(19) United States
(12) Patent Application Publication
(10) Pub. No.: US 2024/0218116 A1
(43) Pub. Date: Jul. 4, 2024

(54) POLYOLEFIN MIMIC POLYESTER COPOLYMERS

(71) Applicant: SABIC Global Technologies B.V., Bergen Op Zoom (NL)

(72) Inventors: Sivadinarayana CHINTA, Bangalore (IN); Alexander STANISLAUS, Bangalore (IN); Girish KORIPELLY, Bangalore (IN); Robbert DUCHATEAU, Bangalore (IN); Kaiwalya SABNIS, Bangalore (IN); Pankaj Singh GAUTAM, Bangalore (IN); Ganesh KANNAN, Bangalore (IN); Ravichander NARAYANASWAMY, Bangalore (IN); Lidia JASINSKA-WALC, Bangalore (IN)

(21) Appl. No.: 18/554,456

(22) PCT Filed: Apr. 8, 2022
(86) PCT No.: PCT/EP2022/059383

§ 371 Date: Oct. 6, 2023

(30) Foreign Application Priority Data
Apr. 8, 2021 (EP) 21167503.8

(51) Int. Cl. C08G 63/16; C08G 63/672; C08G 63/695; C08G 65/331; C08J 11/14; C08J 11/24

(52) U.S. Cl. CPC C08G 63/16; C08G 63/672; C08G 63/6956; C08G 65/3311; C08J 11/14; C08J 11/24; C08J 2367/02

(57) ABSTRACT

A copolymer, methods of making the polymer, methods of recycling the polymer and compositions including the polymer are described. The copolymer, can contain repeating units of Formula (I), and repeating units of Formula (II), for each of Formulas (I) and (II), n is independently 1 and denotes number of repeat units, X is an aliphatic group for each of Formulas (I) and (II), Z is a first polyolefin group comprising at least 45 carbon atoms, preferably 100 to 700 carbon atoms, and has a degree of saturation 98 to 100%; and Z′ is an aliphatic hydrocarbon group. Formula (I) or Formula (II), or both, comprise 0.01 to 40 ester groups per 1,000 backbone carbon atoms

### BACKGROUND OF THE INVENTION

### A. Field of the Invention

The invention generally relates to chemically recyclable polymers.

### B. Description of Related Art

Polyolefins have multiple industrial uses. Polyolefins such as polyethylene and polypropylene constitute the largest volume of synthetic plastic produced worldwide. Polyolefins are used in wide variety of materials, such as films, sheets, foams, fibers, toys, bottles, containers, furniture, electronic parts, and plumbing materials.

An issue with polyolefins is their poor chemical recyclability back to their respective building blocks or monomeric units. For example, the chemical recycling efficiency back to polyolefin building blocks starting from waste plastic is about 40-50%. One reason for this is the chemical recycling process can produce unwanted by-products like aromatics, methane, coke, etc. This means full recycling circularity may not be possible to achieve in the current recycling processes with the polymers currently in use.

### SUMMARY OF THE INVENTION

A discovery has been made that provides a solution to at least some of the problems that may be associated with the chemical recyclability of polymers such as polyolefins. In one aspect, the discovery can include providing polyester copolymers that have polyolefin like properties (e.g., crystallinity, melt temperature (Tₘ), etc.), that can readily be recycled to their respective building blocks. This can increase the chemical recycling efficiency when compared with current polyolefin polymers. In one aspect, it is believed that polyester copolymers, containing at least one block contain 0.01 to 40 ester groups per 1,000 backbone carbon atoms, and having relatively high degree of saturation, can provide polyolefin like properties. Copolymers of the present invention can readily be recycled to the monomers forming the polymer.

One aspect is directed to a copolymer. The copolymer can contain repeating units of Formula I, and repeating units of Formula II:

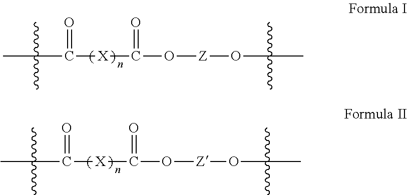

where n can independently be 0 or 1 for each of Formula I and Formula II, and denotes number of repeat units. For example, n in Formula I can be 0 and n in Formula II can be 0 or 1, or n in Formula I can be I and n in Formula II can be 0) or 1. The copolymer contains at least one block (e.g., Formula I and/or Formula II) containing 0.01 to 40 ((e.g., 0.01, 0.1, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 or any value or range there between) ester groups per 1,000 backbone carbon atoms.

Z can be a polyolefin group. In some aspects, Z can contain at least 45 carbon atoms, and can have a degree of saturation 97 to 100%, such as 98 to 100%. In some aspects, Z can contain 45 to 1,000 carbon atoms, such as 50 to 800 carbon atoms, such as 60 to 600 carbon atoms, preferably 100 to 700 carbon atoms connecting the two oxygen atoms. In some aspects, Z can have a degree of branching (DB) of 0) to 50%. In some aspects, Z has a DB of 0 to 5%. In some aspects, Z has a DB of 5 to 50%. A polyolefin group of Z, can be a polyolefin with one H missing at each of the two ends of the polyolefin backbone chain, where the valency of the terminal carbons are satisfied by bonding with the “—O—” groups at the two sides of Z. In some aspects, Z can be a linear polyolefin group. In some aspects, Z can be a branched polyolefin group, having a DB of 0.01 to 50%. In some aspects, Z can contain C₁ to C₁₀ hydrocarbon branches. In some aspects, Z can contain C₁ to C₁₀ alkyl group branches. In some aspects, the polyolefin group of Z can be a polyethylene, polypropylene, poly(ethylene-propylene), or poly(ethylene-co-α-olefin) group. In some aspects, the poly(ethylene-co-α-olefin) group of Z can be poly(ethylene-co-1-butene), poly(ethylene-co-1-hexene), or poly(ethylene-co-1-octene) group. In some aspects, Z can be a linear polyethylene group. In some aspects, Z can be a branched polyethylene group containing C₁ to C₁₀ alkyl group branches, and a DB of 0.01 to 50%. In some aspects, branched polyethylene group of Z can have a DB of 0.01 to 5%. In some aspects, branched polyethylene group of Z can have a DB of 5 to 50%. In some aspects, Z can be an atactic, isotactic, or syndiotactic polypropylene group. In certain aspects, Z can vary randomly between the repeating units of Formula I. In certain aspects, the number of carbon atoms and/or DB of the Z group, such as a polyolefin group of Z, can vary randomly between the repeating units of Formula I. In certain aspects, i) average number of carbon atoms in the Z groups of the polymer can be 45 to 1000, such as 50 to 800, such as 60 to 600, preferably 100 to 700 connecting the two oxygen atoms, ii) the Z groups of the polymer can have a polydispersity index of 1.5 to 4, preferably 1.5 to 3, more preferably 1.5 to 2.5, and/or iii) the average DB of the Z groups of the polymer can be 0 to 50 mol. %. In certain aspects, Z does not vary between the repeating units of Formula I.

The structure of Z can be different than Z′. Z′ can be an aliphatic group. In some aspects, Z′ can have a degree of saturation 97 to 100%, such as 98 to 100%. In some aspects, Z′ can contain 1 to 1,000 carbon atoms, such as 5 to 800 carbon atoms, such as 10 to 600 carbon atoms. In some aspects, Z′ can have a degree of branching (DB) 0 to 50%. In some aspects, Z′ has a DB of 0 to 5%. In some aspects, Z′ has a DB of 5 to 50%. In some aspects, Z′ can be a linear hydrocarbon. In some aspects, Z′ can be a branched hydrocarbon. In some aspects, Z′ can be a polyolefin group, and can contain 45 to 1,000 carbon atoms, such as 50 to 800 carbon atoms, such as 60 to 600 carbon atoms, preferably 100 to 700 carbon atoms connecting the two oxygen atoms. A polyolefin group of Z′, can be a polyolefin with one H missing at each of the two ends of the polyolefin backbone chain, where the valency of the terminal carbons are satisfied by bonding with the “—O—” groups at the two sides of Z′. In some aspects, Z′ can be a linear polyolefin group. In some aspects, Z′ can be a branched polyolefin group, having a DB of 0.01 to 50%. In some aspects, Z′ can be a branched polyolefin group having a DB of 0.01 to 5%. In some aspects, Z′ can be a branched polyolefin group having a DB of 5 to 50%. In some aspects, polyolefin group of Z′ can contain C₁ to C₁₀ hydrocarbon branches. In some aspects, polyolefin group of Z′ can contain C₁ to C₁₀ alkyl group branches. In some aspects, the polyolefin group of Z′ can be a polyethylene, polypropylene, poly(ethylene-co-propylene), or poly(ethylene-co-α-olefin) group. In some aspects, the poly(ethylene-co-α-olefin) group of Z′ can be a poly(ethylene-co-1-butene), poly(ethylene-co-1-hexene), or poly(ethylene-co-1-octene) group. In some aspects, Z′ can be a linear polyethylene group. In some aspects, Z′ can be a branched polyethylene group containing C₁ to C₁₀ alkyl group branches, and a DB of 0.01 to 50%, such as 0.01 to 5%, or 5 to 50%. In some aspects, Z′ can be an atactic, isotactic, or syndiotactic polypropylene group. In certain aspects, Z′ can be a polyolefin group and vary randomly between the repeating units of Formula II. In certain aspects, number of carbon atoms and/or DB of the polyolefin Z′ groups can vary randomly between the repeating units of Formula II. In certain aspects, i) average number of carbon atoms in the polyolefin Z′ groups of the polymer can be 45 to 1000, such as 50 to 800, such as 60 to 600, ii) the polyolefin Z′ groups of the polymer can have a polydispersity index of 1.5 to 4, preferably 1.5 to 3, more preferably 1.5 to 2.5, and/or iii) the average DB of the polyolefin Z′ groups of the polymer can be 0 to 50 mol. %. In certain aspects, polyolefin Z′ groups do not vary between the repeating units of Formula II.

In some aspects, Z′ can be a polyether group. A polyether group can be a polyether with one H missing at each of the two ends of the polyether backbone chain, where the valency of the terminal carbons are satisfied by bonding with the “—O—” groups at the two sides of Z′. The polyether group can contain 45 to 1,000 atoms (e.g., carbon and oxygen atoms in total) in the polymer backbone. The polyether can be a linear or a branched polyether. In some aspects, Z′ can be a branched polyether group, having a DB of 0.01 to 50%. The branched polyether can contain C₁ to C₁₀ hydrocarbon branches. In some aspects, the branched polyether can contain C₁ to C₁₀ alkyl group branches. In some aspects, Z′ can be poly(ethylene oxide), poly(ethylene oxide-co-propylene oxide), poly(ethylene oxide-block-propylene oxide), poly(propylene oxide) or poly(tetramethylene oxide). In certain aspects, Z′ can be a polyether group and vary randomly between the repeating units of Formula II. In certain aspects, number of carbon and oxygen atoms and/or DB of the polyether Z′ groups can vary randomly between the repeating units of Formula II. In certain aspects, i) average number of carbon and oxygen atoms (in total) in the polyether Z′ groups of the polymer can be 45 to 1000, such as 50 to 800, such as 60 to 600, ii) the polyether Z′ groups of the polymer can have a polydispersity index of 1.01 to 2.0, preferably 1.1 to 1.5 and/or iii) the average DB of the polyether Z′ groups of the polymer can be 0 to 50 mol. %.

In some aspects, Z′ can be a polydimethylsiloxane group. A polydimethylsiloxane group can be a polydimethylsiloxane with one H missing at each of the two ends of the polydimethylsiloxane backbone chain, where the valency of the terminal siloxane are satisfied by bonding with the “13 O'” groups at the two sides of Z′. The polydimethylsiloxane group can contain 45 to 1,000 atoms (e.g., silicon and oxygen atoms in total) in the polydimethylsiloxane group backbone. In some aspects Z′ can be hydroxy terminated poly(dimethylsiloxane), hydroxy propyl terminated poly(dimethylsiloxane or bis(hydroxyalkyl) terminated poly(dimethylsiloxane). In certain aspects, Z′ can be a polydimethylsiloxane group and vary randomly between the repeating units of Formula II. In certain aspects, number of atoms (e.g., silicon and oxygen atoms in total) in the polydimethylsiloxane group backbone of the polydimethylsiloxane Z′ groups can vary randomly between the repeating units of Formula II. In certain aspects, i) average number of atoms in the polydimethylsiloxane group backbone of the polydimethylsiloxane Z′ groups of the polymer can be 45 to 1000, and/or the polydimethylsiloxane Z′ groups in the polymer can have a PDI of 1.01 to 4.

In some aspects, Z′ can be a polystyrene, styrene-butadiene copolymer, polybutadiene group, or substituted polybutadiene group. In some aspects, the substituted polybutadiene group can be polyisoprene group. In some aspects, the polystyrene, styrene-butadiene copolymer, polybutadiene group can contain at least 45 carbon atoms, and can have a degree of saturation of the main chain of 60 to 100%, such as 75 to 100%. In some aspects, Z′ can contain 45 to 1,000 carbon atoms, such as 50 to 800 carbon atoms, such as 60 to 600 carbon atoms. A polystyrene or styrene-butadiene copolymer or polybutadiene group of Z′, can be a polystyrene or styrene-butadiene copolymer or polybutadiene with one H missing at each of the two ends of the polystyrene or styrene-butadiene copolymer or polybutadiene backbone chain, where the valency of the terminal carbons are satisfied by bonding with the “—O—” groups at the two sides of Z′. In some aspects, the polystyrene or styrene-butadiene copolymer or polybutadiene group of Z′ can be a polystyrene, polybutadiene, random poly(styrene-co-butadiene), poly(styrene-block-polybutadiene) diblock copolymer or poly(styrene-block-polybutadiene-block-styrene) triblock copolymer group. In certain aspects, Z′ can be a polystyrene, styrene-butadiene copolymer or polybutadiene group and can vary randomly between the repeating units of Formula II. In certain aspects, number of carbon atoms in the polystyrene, styrene-butadiene copolymer or polybutadiene Z′ groups can vary randomly between the repeating units of Formula II. In certain aspects, i) average number of carbon atoms in the polystyrene, styrene-butadiene copolymer or polybutadiene Z′ groups can be 45 to 1000, preferably 100 to 700 carbon atoms connecting the two oxygen atoms and/or the polystyrene, styrene-butadiene copolymer or polybutadiene Z′ groups in the polymer can have a PDI of 1.01 to 2, preferably 1.05 to 1.5.

In certain aspects, Z′ groups do not vary between the repeating units of Formula II.

X in each of Formula I and Formula II can independently be an aliphatic group. X in each of Formula I and Formula Il can independently contain up to 1000 carbon atoms. In some aspects, X in each of Formula I and Formula II can independently be a linear hydrocarbon. In some aspects, X in each of Formula I and Formula II can independently be a branched hydrocarbon. In some aspects, X in each of Formula I and Formula II can independently be a polyolefin group. A polyolefin group of X can be a polyolefin with one H missing at each of the two ends of the polyolefin backbone chain, where the valency of the terminal carbons are satisfied by bonding with the “—COO—” groups at the two sides of X. In some aspects, X in each of Formula I and Formula II can independently be a linear polyolefin group. In some aspects, X in each of Formula I and Formula II can independently be a branched polyolefin group having a DB of 0.01 to 50%. In some aspects, X in each of Formula I and Formula II can independently contain C₁ to C₁₀ hydrocarbon branches. In some aspects, X in each of Formula I and Formula II can independently be a polyethylene, poly(ethylene-propylene), poly(α-olefin), poly(α-olefin-co-ethylene), or poly(ethylene-co-α-olefin) group. In certain aspects, X in each of Formula I and Formula II can independently be a poly(ethylene-co-1-butene), poly(ethylene-co-1-hexene), or poly(ethylene-co-1-octene) group. In some aspects, X in each of Formula I and Formula II can independently be a polypropylene group, or a polybutylene group, or a poly(propylene-co-ethylene) group. In some aspects, X in each of Formula I and Formula II can independently be an atactic, isotactic, or syndiotactic polypropylene group. In some aspects, X in each of Formula I and Formula II can independently be a random poly(propylene-co-ethylene) group. In certain aspects, X in Formula I can vary randomly between the repeating units of Formula I. In certain aspects, i) the number of carbon atoms in the X groups can vary randomly between the repeating units of Formula I or iii) the DB of the X groups can vary randomly between the repeating units of Formula I. In certain aspects, X does not vary between the repeating units of Formula I. In certain aspects, X in Formula I can vary randomly between the repeating units of Formula II. In certain aspects, i) the number of carbon atoms in the X groups can vary randomly between the repeating units of Formula II or iii) the DB of the X groups can vary randomly between the repeating units of Formula II. In certain aspects, X does not vary between the repeating units of Formula II.

In certain aspects, X in each of Formula I and Formula II can independently contain 45 to 1000 carbon atoms. In certain aspects, X in each of Formula I and Formula II can independently be a C₁ to C₄₄ aliphatic group. In some particular aspects, X in each of Formula I and Formula II can independently be a C₁ to C₂₀ aliphatic group. For example, X can have the same or a different structure in each of Formula I and Formula II. In some aspects, X can have the same structure in Formula I and Formula II. In some aspects, X can have different structures in Formula I and Formula II. In some aspects, X can independently be a linear or branched, and substituted or unsubstituted hydrocarbon in each of Formula I and Formula II. In some aspects, X can independently have the formula of (1), (2), (3), (4), or (5), in each of Formula I and Formula II:

In some aspects, X in each of Formula I and Formula II can independently be a linear or branched, and substituted or unsubstituted hydrocarbon. In some aspects, X in each of Formula I and Formula II can independently have the formula of (1), (2), (3), (4), or (5):

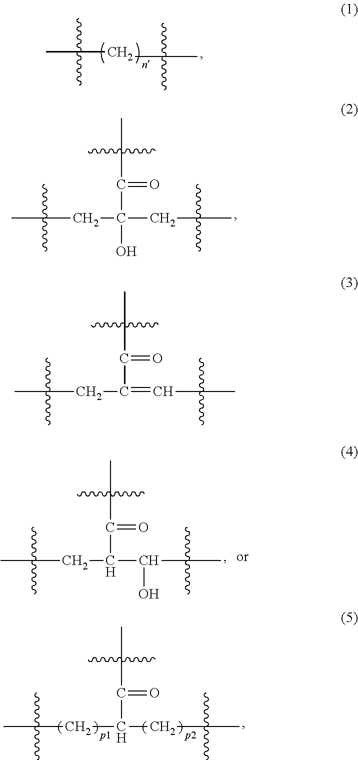

wherein n′ in formula (1) is an integer from 1 to 1000, and denotes number of repeat units: p1, and p2 in formula (5) can independently be an integer from 0 to 5, and denote number of repeat units. In certain aspects, n′ can be an integer from 1 to 15.

In certain aspects, the copolymer can contain i) repeating units of a first unit having the formula of Formula I, and ii) repeating units of a second unit having the formula of Formula I, wherein X of the first unit can have a different formula than the X of the second unit. In certain aspects, the copolymer can contain i) repeating units of a third unit having the formula of Formula II, and ii) repeating units of a fourth unit having the formula of Formula II, wherein X of the third unit can have a different formula than the X of the fourth unit.

In some aspects, the number average molecular weight (Mₙ) of the copolymer can be 10,000 to 1,000,000 g/mol, such as 20,000 to 500,000 g/mol, such as 40,000 to 200,000 g/mol. The Mₙ can be determined as the polyethylene equivalent molecular weight by high temperature size exclusion chromatography performed at 160° C. in trichlorobenzene using polyethylene standards. In some aspects, the polymer can have a polydispersity index (PDI), of 1.5 to 4, preferably 1.8 to 3. In some aspects, the copolymer can contain at least one amorphous block, and at least one semi-crystalline block. In some aspects, the block copolymer can contain at least two amorphous blocks, wherein the glass transition temperature (T_{g}) of the two blocks can be different. In some aspects, the units of Formula I and units of Formula II can be arranged in the copolymer randomly, alternatively, or in blocks. In some particular aspects, the units of Formula I and units of Formula II can be arranged in the copolymer randomly. In certain aspects, the copolymer can be a statistical copolymer.

In some aspects, the Z and Z′ groups in the copolymer can be such that melt temperatures (Tₘ) of a polymer, such as a homopolymer, formed by the Z groups of the copolymer, and a polymer, such as a homopolymer, formed by the Z′ groups of the copolymer, can differ by at least 40° C., such as 40° C. to 180° C., such as 85° C. to 170° C., such as 90° C. to 150° C. In some aspects, the Z and Z′ groups in the copolymer can be such that glass transition temperature (T_{g}) of a polymer, such as a homopolymer, formed by the Z groups of the copolymer, and a polymer, such as a homopolymer, formed by the Z′ groups of the copolymer, can differ by at least 5° C., such as by at least 10° C., such as by at least 20° C., such as by at least 30° C., such as by at least 40° C., such as by at least 50° C., such as by at least 100° C., such as at least by 140° C. In some aspects, the Z and Z′ groups in the copolymer can be such that crystallinity at room temperature of a polymer, such as a homopolymer, formed by the Z groups of the copolymer, and a polymer, such as a homopolymer, formed by the Z′ groups of the copolymer, can differ by at least 5%, such as by at least 10%, such as by at least 20%, such as by at least 30%, such as by at least 40%. In certain aspects, a polymer, such as a homopolymer, formed by the Z groups of the copolymer, and a polymer, such as a homopolymer, formed by the Z′ groups of the copolymer can be semi-crystalline at room temperature. In certain aspects, a polymer, such as a homopolymer, formed by the Z groups of the copolymer, and the polymer, such as a homopolymer, formed by the Z′ groups of the copolymer can be amorphous at room temperature. In certain aspects, a polymer, such as a homopolymer, formed by the Z groups of the copolymer can be amorphous, and a polymer, such as a homopolymer, formed by the Z′ groups of the copolymer can be semi-crystalline at room temperature. In certain aspects, a polymer, such as a homopolymer, formed by the Z groups of the copolymer can be semi-crystalline, and the polymer, such as a homopolymer, formed by the Z′ groups of the copolymer can be amorphous at room temperature.

In certain aspects, the Formula I can be Formula III, and the Formula II can be Formula IV, and the copolymer can contain repeating units of Formula III, and repeating units of Formula IV

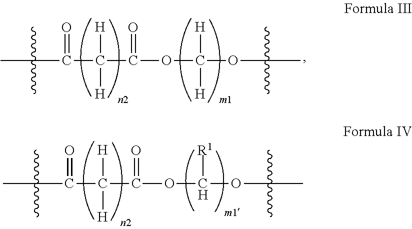

wherein i) n2 can independently be an integer from 0 to 15, such as 1, 2, 3, 4, 5, 6, 7, 8, 9, 10, 11, 12, 13, 14 or 15, for each of Formula III and IV, and denotes number of repeat units; ii) m1 can be an integer from 45 to 1000, or equal to any one of, at least any one of, or between any two of 45, 50, 60, 70, 80, 90, 100, 150, 200, 250, 300, 350, 400, 450, 500, 550, 600, 650, 700, 750, 800, 850, 900, 950 and 1000, and denotes number of repeat units; iii) m1′ can be an integer from 45 to 1000, or equal to any one of, at least any one of, or between any two of 45, 50, 60, 70, 80, 90, 100, 150, 200, 250, 300, 350, 400, 450, 500, 550, 600, 650, 700, 750, 800, 850, 900.

950 and 1000, and denotes number of repeat units; iv) R¹ can be —H or a C₁ to C₁₀ alkyl group, and can vary independently between H and the C₁ to C₁₀ alkyl group in the repeating units —CHR¹—; v) the —(CHR¹)_{m1′}13 group can have a DB of 5% or higher, such as 5 to 50%, or equal to any one of, at least any one of, or between any two of 5, 6, 7, 8, 9, 10, 12, 15, 20, 25, 30, 35, 40, 45 and 50%; or any combinations thereof. In some aspects, n2 can be 2 for each of Formula III and IV. In some aspects, R¹ can be —H or —CH₃. In some aspects, R¹ can be —H or —CH₂CH₃. In some aspects, R¹ can be —H or a C₃ alkyl group. In some aspects, R¹ can be —H or a C₄ alkyl group. In some aspects, R¹ can be —H or a C₅ alkyl group. In some aspects, R¹ can be —H or a C₆ alkyl group. In some aspects, R¹ can be —H or a C₇ alkyl group. In some aspects. R¹ can be —H or a C₈ alkyl group. In some aspects, R¹ can be —H or a C₉ alkyl group. In some aspects, R¹ can be —H or a C₁₀ alkyl group. In certain aspects, m1 can vary randomly between the repeating units of Formula III, and/or average of m1′ in the polymer can be 60 to 600. In certain aspects, m1 does not vary between the repeating units of Formula III. In certain aspects, m1′ can vary randomly between the repeating units of Formula IV, and/or average of m1′s in the polymer can be 45 to 800. In certain aspects, m1′ does not vary between the repeating units of Formula IV. In certain aspects, DB of the —(CHR¹)_{m1′}— group can vary randomly between the repeating units of Formula IV, and/or the average DB of the —(CHR¹)_{m1′}— groups of the polymer can be 5 to 50%. In certain aspects, DB of the —(CHR¹)_{m1′}— group between the repeating units of Formula IV does not vary.

In certain aspects, the Formula I can be Formula V, and the Formula II can be Formula VI, and the copolymer can contain repeating units of Formula V, and repeating units of Formula VI,

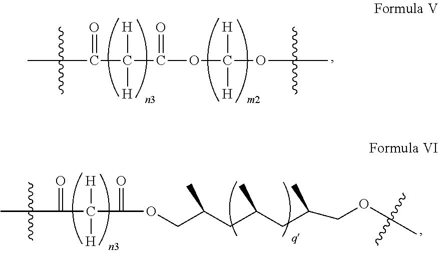

wherein i) n3 can independently be an integer from 0 to 15, such as 1, 2, 3, 4, 5, 6, 7, 8, 9, 10, 11, 12, 13, 14 or 15, for each of Formulas V and VI, and denotes number of repeat units; ii) m2 can be an integer from 60 to 600, or equal to any one of, at least any one of, or between any two of 60, 70, 80, 90, 100, 150, 200, 250, 300, 350, 400, 450, 500, 550, and 600, and denotes number of repeat units; iii) q′ can be an integer from 25 to 200, and 50 to 125, or equal to any one of, at least any one of, or between any two of 25, 30, 40, 50, 60, 70, 80, 90, 100, 125, 150, 175 and 200, and denotes number of repeat units; or any combinations thereof. In some aspects, n3 can be 2 for each of Formula V and VI. In certain aspects, m2 can vary randomly between the repeating units of Formula V, and/or the average of m2s in the polymer can be 60 to 600, or equal to any one of, at least any one of, or between any two of 60, 70, 80, 90, 100, 150, 200, 250, 300, 350, 400, 450, 500, 550, and 600. In certain aspects, m2 does not vary between the repeating units of Formula V. In certain aspects, q′ can vary randomly between the repeating units of Formula VI, and/or average of q′s in the polymer can be 25 to 200, or equal to any one of, at least any one of, or between any two of 25, 30, 40, 50, 60, 70, 80, 90, 100, 125, 150, 175 and 200. In certain aspects, q′ does not vary between the repeating units of Formula VI.

In certain aspects, the Formula I can be Formula VII, and the Formula II can be Formula VIII, and the copolymer can contain repeating units of Formula VII, and repeating units of Formula VIII

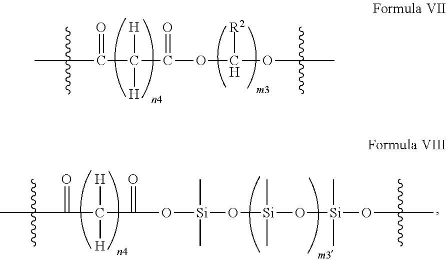

wherein, i) n4 can independently be an integer from 0 to 15, such as 1, 2, 3, 4, 5, 6, 7, 8, 9, 10, 11, 12, 13, 14 or 15, for each of Formulas VII and VIII, and denotes number of repeat units; ii) R² can be —H or a C₁ to C₁₀ alkyl group, and varies independently between H and the C₁ to C₁₀ alkyl group in the repeating units —CHR²—; iii) the —(CHR²)ₘ₃— group can have a DB of 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50; iv) m3 can be an integer from 45 to 600, or equal to any one of, at least any one of, or between any two of 45, 50, 60, 70, 80, 90, 100, 150, 200, 250, 300, 350, 400, 450, 500, 550, and 600, and denotes number of repeat units; v) m3′ can be an integer from 20 to 497, or equal to any one of, at least any one of, or between any two of 20, 25, 30, 35, 40, 50, 60, 70, 80, 90, 100, 150, 200, 250, 300, 350, 400, 450, and 497, and denotes number of repeat units; or any combinations thereof. In some aspects, n4 can be 2 for each of Formula VII and VIII. In some aspects, R² can be —H or —CH₃. In some aspects, R² can be —H or —CH₂CH₃. In some aspects, R² can be —H or a C₃ alkyl group. In some aspects. R² can be —H or a C₄ alkyl group. In some aspects, R² can be —H or a C₅ alkyl group. In some aspects, R² can be —H or a C₆ alkyl group. In some aspects, R² can be —H or a C₇ alkyl group. In some aspects, R² can be —H or a C₈ alkyl group. In some aspects, R² can be —H or a C₉ alkyl group. In some aspects, R² can be —H or a C₁₀ alkyl group. In certain aspects, m3 can vary randomly between the repeating units of Formula VII, and/or average of m3s in the polymer can be 45 to 600, or equal to any one of, at least any one of, or between any two of 45, 50, 60, 70, 80, 90, 100, 150, 200, 250, 300, 350, 400, 450, 500, 550, and 600. In certain aspects, m3 does not vary between the repeating units of Formula VII. In certain aspects, DB of the —(CHR²)ₘ₃— group can vary randomly between the repeating units of Formula VII, and/or the average DB of the —(CHR²)ₘ₃— groups of the polymer can be 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%. In certain aspects, DB of the —(CHR²)ₘ₃— group between the repeating units of Formula VII does not vary. In certain aspects, m3′ can vary randomly between the repeating units of Formula VIII, and/or average of m3′s in the polymer can be 20 to 497, or equal to any one of, at least any one of, or between any two of 20, 25, 30, 35, 40, 50, 60, 70, 80, 90, 100, 150, 200, 250, 300, 350, 400, 450, and 497. In certain aspects, m3′ does not vary between the repeating units of Formula VIII.

In certain aspects, the Formula I can be Formula IX, and the Formula II can be

Formula X, and the copolymer can contain repeating units of Formula IX, and repeating units of Formula X.

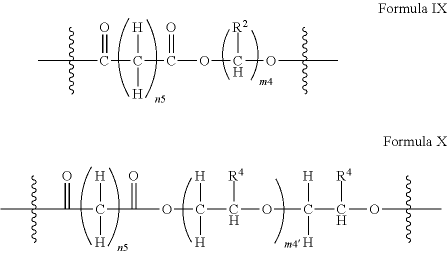

wherein i) n5 can independently be an integer from 0 to 15, such as 1, 2, 3, 4, 5, 6, 7, 8, 9, 10, 11, 12, 13, 14 or 15, for each of Formulas IX and X, and denotes number of repeat units; ii) R³ can be —H or a C₁ to C₁₀ alkyl group, and varies independently between —H and the C₁ to C₁₀ alkyl group in the repeating units —CHR³—; iii) the —(CHR³)ₘ₄— group can have a DB of 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%; iv) m4 can be an integer from 60 to 600, or equal to any one of, at least any one of, or between any two of 60, 70, 80, 90, 100, 150, 200, 250, 300, 350, 400, 450, 500, 550, and 600, and denotes number of repeat units; v) m4′ can be an integer from 1 to 332, or equal to any one of, at least any one of, or between any two of 1, 5, 10, 15, 20, 25, 30, 35, 40, 50, 60, 70, 80, 90, 100, 150, 200, 250, 300, and 332, and denotes number of repeat units; vi) R⁴ is a C₁ to C₁₀ alkyl group; or any combinations thereof.

In some aspects, n5 can be 2 for each of Formula IX and X. In some aspects, R³ can be —H or —CH_{3.} In some aspects, R³ can be —H or —CH₂CH₃. In some aspects, R³ can be —H or C₃ alkyl group. In some aspects, R³ can be —H or a C₄ alkyl group. In some aspects, R³ can be —H or a ₅ alkyl group. In some aspects, R³ can be —H or a C₆ alkyl group. In some aspects, R³ can be —H or a C₇ alkyl group. In some aspects, R³ can be —H or a C₈ alkyl group. In some aspects, R³ can be —H or a C₉ alkyl group. In some aspects, R³ can be —H or a C₁₀ alkyl group. In certain aspects, m4 can vary randomly between the repeating units of Formula IX, and/or average of m4s in the polymer can be 60 to 600, or equal to any one of, at least any one of, or between any two of 45, 50, 60, 70, 80, 90, 100, 150, 200, 250, 300, 350, 400, 450, 500, 550, and 600.

In certain aspects, m4 does not vary between the repeating units of Formula IX. In certain aspects, DB of the —(CHR³)ₘ₄— group can vary randomly between the repeating units of Formula IX, and/or the average DB of the —(CHR³)ₘ₄— groups of the polymer can be 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%. In certain aspects, DB of the —(CHR³)ₘ₄13 group between the repeating units of Formula IX does not vary. In certain aspects, m4′ can vary randomly between the repeating units of Formula X, and/or average of m4's in the polymer can be 1 to 332, or equal to any one of, at least any one of, or between any two of 1, 5, 10, 15, 20, 25, 30, 35, 40, 50, 60, 70, 80, 90, 100, 150, 200, 250, 300, and 332. In certain aspects, m3′ does not vary between the repeating units of Formula VIII.

In certain aspects, the Formula I can be Formula XII, and the Formula II can be Formula XIII, and the copolymer can contain repeating units of Formula XII, and repeating units of Formula XIII,

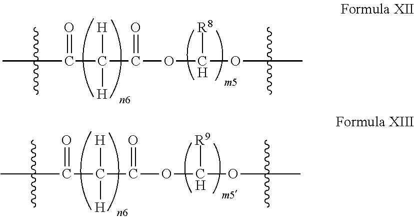

wherein i) n6 can independently be an integer from 0 to 15, such as 1, 2, 3, 4, 5, 6, 7, 8, 9, 10, 11, 12, 13, 14 or 15, for each of Formula XII and XIII, and denotes number of repeat units; ii) m5 can be an integer from 60 to 600, or equal to any one of, at least any one of, or between any two of 45, 50, 60, 70, 80, 90, 100, 150, 200, 250, 300, 350, 400, 450, 500, 550, and 600, and denotes number of repeat units; iii) R⁸ can be —H or a C₁ to C₁₀ alkyl group, and can vary independently between —H and the C₁ to C₁₀ alkyl group in the repeating units —CHR⁸—; iv) the —(CHR⁸)ₘ₅— group can have a DB of 0.01 to less than 5%, or equal to any one of, at most any one of, or between any two of 0.01, 0.1, 0.5, 1, 2, 3, 4, or less than 5%; v) m5′ can be an integer from 5 to 800, or equal to any one of, at least any one of, or between any two of 5, 10, 15, 20, 25, 30, 35, 40, 45, 50, 60, 70, 80, 90, 100, 150, 200, 250, 300, 350, 400, 450, 500, 550, 600, 700, and 800, and denotes number of repeat units; vi) R⁹ can be —H or a C₁ to C₁₀ alkyl group, and can vary independently between —H and the C₁ to C₁₀ alkyl group in the repeating units —CHR⁹—; vii) the —(CHR⁹)ₘ₅′— group can have a DB of 5% or higher, such as 5% to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%; or any combinations thereof. In some aspects, n6 can be 2 for each of Formula XII and XIII. In some aspects, the —(CHR⁸)m₅— group can have a DB of 0.01 to 3%. In some aspects, R⁸ can be —H or —CH₃. In some aspects, R⁸ can be —H or —CH₂CH₃. In some aspects, R⁸ can be —H or a C₃ alkyl group. In some aspects, R⁸ can be —H or a C₄ alkyl group. In some aspects, R⁸ can be —H or a C₅ alkyl group. In some aspects, R⁸ can be —H or a C₆ alkyl group. In some aspects, R⁸ can be —H or a C₇ alkyl group. In some aspects, R⁸ can be —H or a C₈ alkyl group. In some aspects, R⁸ can be —H or a C₉ alkyl group. In some aspects, R⁸ can be —H or a C₁₀ alkyl group. In some aspects, R⁹ can be —H or —CH₃. In some aspects, R⁹ can be —H or —CH₂CH₃. In some aspects, R⁹ can be —H or a C₃ alkyl group. In some aspects, R⁹ can be —H or a C₄ alkyl group. In some aspects, R⁹ can be —H or a C₅ alkyl group. In some aspects, R⁹ can be —H or a C₆ alkyl group. In some aspects, R⁹ can be —H or a C₇ alkyl group. In some aspects, R⁹ can be —H or a C₈ alkyl group. In some aspects, R⁹ can be —H or a C₉ alkyl group. In some aspects, R⁹ can be —H or a C₁₀ alkyl group. In certain aspects, m5 can vary randomly between the repeating units of Formula XII, and/or average of m5s in the polymer can be 60 to 600, or equal to any one of, at least any one of, or between any two of 60, 70, 80, 90, 100, 150, 200, 250, 300, 350, 400, 450, 500, 550, and 600. In certain aspects, m5 does not vary between the repeating units of Formula XII. In certain aspects, DB of the —(CHR⁸)ₘ₅— group can vary randomly between the repeating units of Formula XII, and/or the average DB of the —(CHR⁸)ₘ₅— groups of the polymer can be 0.01 to less than 5%, or equal to any one of, at most any one of, or between any two of 0.01, 0.1, 0.5, 1, 2, 3, 4, or less than 5%. In certain aspects, the DB of the —(CHR⁸)ₘ₅— group between the repeating units of Formula XII does not vary. In certain aspects, m5′ can vary randomly between the repeating units of Formula XIII, and/or average of mS's in the polymer can be 5 to 800, or equal to any one of, at least any one of, or between any two of 5, 10, 15, 20, 25, 30, 35, 40, 45, 50, 60, 70, 80, 90, 100, 150, 200, 250, 300. 350, 400, 450, 500, 550, 600, 700, and 800. In certain aspects, m5 does not vary between the repeating units of Formula XIII. In certain aspects, the DB of the —(CHR⁹)_{m5′}— group can vary randomly between the repeating units of Formula XIII, and/or the average DB of the —(CHR⁹)_{m5′}— - groups of the polymer can be 5 to 50%, or equal to any one of, at least any one of, or between any two of 5, 6, 7, 8, 9, 10, 12, 15, 20, 25, 30, 35, 40, 45 and 50%.

In certain aspects, the Formula I can be Formula XIV, and the Formula II can be Formula XV or Formula XVI, and the copolymer can contain repeating units of i) Formula XV, and ii) Formula XV or Formula XVI,

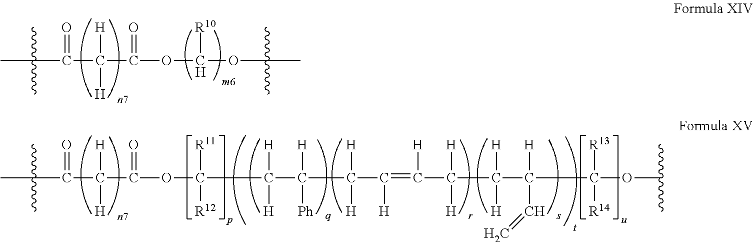

wherein in Formula XV, —CR¹¹R¹²— group and CR¹³R¹⁴— are linear or branched hydrocarbons, p and u are independently an integer from 1 to 5, such as 1, 2, 3, 4 or 5; q, r, s, t are integers and can be independently chosen such that (q+r/2+s)×2×t≤1000−p−u, and —Ph is a phenyl group. R¹¹ can be —H or a C₁ to C₁₀ alkyl group, and can vary independently between —H and the C₁ to C₁₀ alkyl group in the repeating units —CR¹¹R¹²— group. R¹² can be —H or a C₁ to C₁₀ alkyl group, and can vary independently between —H and the C₁ to C₁₀ alkyl group in the repeating units —CR¹¹R¹²— group. R¹³ can be —H or a C₁ to C₁₀ alkyl group, and can vary independently between —H and the C1 to Cio alkyl group in the repeating units —CR¹³R¹⁴— group. R¹⁴ can be —H or a C₁ to C₁₀ alkyl group, and can vary independently between —H and the C₁ to C₁₀ alkyl group in the repeating units —CR¹³R¹⁴— group.

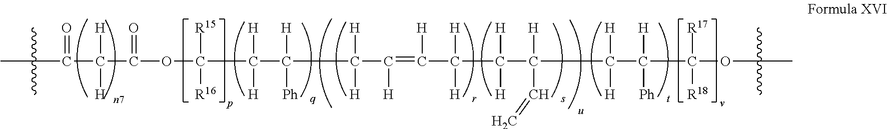

wherein in Formula XVI, —CR¹⁵R¹⁶— group and —CR¹⁷R¹⁸— are linear or branched hydrocarbons , p and v are independently an integer from 1 to 5, such as 1, 2, 3, 4 or 5; q, r, s, t, u are integers and can be independently chosen such that (q+(r/2+s)×u+t)×2<1000−p−v. and —Ph is a phenyl group. R¹⁵ can be —H or a C₁ to C₁₀ alkyl group, and can vary independently between —H and the C₁ to C₁₀ alkyl group in the repeating units —CR¹⁵R¹⁶— group. R¹⁶ can be —H or a C₁ to C₁₀ alkyl group, and can vary independently between —H and the C₁ to C₁₀ alkyl group in the repeating units —CR¹⁵R¹⁶— group. R¹⁷ can be —H or a C₁ to C₁₀ alkyl group, and can vary independently between —H and the C₁ to C₁₀ alkyl group in the repeating units —CR¹⁷R¹⁸— group. R¹⁸ can be —H or a C₁ to C₁₀ alkyl group, and can vary independently between —H and the C₁ to C₁₀ alkyl group in the repeating units —CR¹⁷R¹⁸— group. Wherein i) n7 can independently be an integer from 0 to 15, such as 1, 2, 3, 4, 5, 6, 7, 8, 9, 10, 11, 12, 13, 14 or 15, for each of Formula XIV, XV and XVI, and denotes number of repeat units; ii) m6 can be an integer from 60 to 600, or equal to any one of, at least any one of, or between any two of 60, 70, 80, 90, 100, 150, 200, 250, 300, 350, 400, 450, 500, 550, and 600, and denotes number of repeat units: iii) R¹⁰ can be —H or a C₁ to C₁₀ alkyl group, and can vary independently between H and the C₁ to C₁₀ alkyl group in the repeating units —CHR¹⁰—; and/or iv) the —(CHR¹⁰)ₘ₆— group can have a DB of 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%. In some aspects, n7 can be 2 for each of Formula XIV, XV and XVI. In some aspects, R¹⁰ can be —H or —CH₃. In some aspects, R¹⁰ can be —H or —CH CH₃. In some aspects, R¹⁰ can be —H or a C₃ alkyl group. In some aspects, R¹⁰ can be —H or a C₄ alkyl group. In some aspects, R¹⁰ can be —H or a C₅ alkyl group. In some aspects, R¹⁰ can be —H or a C₆ alkyl group. In some aspects, R¹⁰ can be —H or a C₇ alkyl group. In some aspects, R¹⁰ can be —H or a C₈ alkyl group. In some aspects. R¹⁰ can be —H or a C₉ alkyl group. In some aspects, R¹⁰ can be —H or a C₁₀ alkyl group. In certain aspects, m6 can vary randomly between the repeating units of Formula XIV, and/or average of m6s in the polymer can be 60 to 600, or equal to any one of, at least any one of, or between any two of 60, 70, 80, 90, 100, 150, 200, 250, 300, 350, 400, 450, 500, 550, and 600. In certain aspects, m6 does not vary between the repeating units of Formula XIV. In certain aspects, DB of the —(CHR¹⁰)ₘ₆— group can vary randomly between the repeating units of Formula XIV, and/or the average DB of the —(CHR¹⁰)ₘ₆— groups of the polymer can be 0.01 to 50%, or equal to any one of, at least any one of, or between any two of 0, 0.01, 0.1, 1, 2, 3, 4, 5, 6, 7, 8, 9, 10, 12, 15, 20, 25, 30, 35, 40, 45 and 50%. In certain aspects, DB of the —(CHR¹⁰)ₘ₆— group between the repeating units of Formula XIV does not vary.

In certain aspects, the Formula I can be Formula III, and the Formula II can be Formula XVII and the copolymer can contain repeating units of i) Formula III, and ii) Formula XVII,

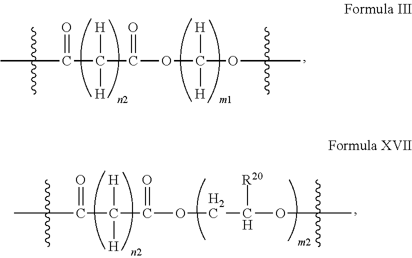

wherein i) n2 is independently an integer from 0 to 15 and denotes number of repeat units, ii) m1 can be an integer from 45 to 1000, or equal to any one of, at least any one of, or between any two of 45, 50, 60, 70, 80, 90, 100, 150, 200, 250, 300, 350, 400, 450, 500, 550, 600, 650, 700, 750, 800, 850, 900, 950 and 1000, and denotes number of repeat units; iii) m2 is an integer from 60 to 600, or equal to any one of, at least any one of, or between any two of 60, 70, 80, 90, 100, 150, 200, 250, 300, 350, 400, 450, 500, 550, 600, and denotes number of repeat units, and R¹ is a C1 to C10 aliphatic hydrocarbon. R²⁰ can be —H or a C₁ to C₁₀ alkyl group, and can vary independently between H and the C₁ to C₁₀ alkyl group in the repeating units —CHR²⁰; v) the —(CHR²⁰)_{m2′}— group can have a DB of 5% or higher, such as 5 to 50%, or equal to any one of, at least any one of, or between any two of 5, 6, 7, 8, 9, 10, 12, 15, 20, 25, 30, 35, 40, 45 and 50%; or any combinations thereof. In some aspects, n2 can be 2 for each of Formula III and XVII. In some aspects, R¹ can be —H or —CH₃. In some aspects, R¹ can be —H or —CH₂CH₃. In some aspects, R¹ can be —H or a C₃ alkyl group. In some aspects, R¹ can be —H or a C₄ alkyl group. In some aspects, R¹ can be —H or a C₅ alkyl group. In some aspects, R¹ can be —H or a C₆ alkyl group. In some aspects, R¹ can be —H or a C₇ alkyl group. In some aspects, R¹ can be —H or a C₈ alkyl group. In some aspects, R¹ can be —H or a C₉ alkyl group. In some aspects, R¹ can be —H or a C₁₀ alkyl group. In certain aspects, m1 can vary randomly between the repeating units of Formula III, and/or average of mls in the polymer can be 60 to 600. In certain aspects, m1 does not vary between the repeating units of Formula III. In certain aspects, m2 can vary randomly between the repeating units of Formula XVII, and/or average of m2s in the polymer can be 60 to 600. In certain aspects, m2 does not vary between the repeating units of Formula XVII. In certain aspects, DB of the —(CHR²⁰)ₘ₂— group can vary randomly between the repeating units of Formula XVII, and/or the average DB of the —(CHR²⁰)ₘ₂— groups of the polymer can be 5 to 50%. In certain aspects, DB of the —(CHR²⁰)ₘ₂— group between the repeating units of Formula XVII does not vary.

Certain aspects are directed to a method for forming a copolymer described herein. The method can include reacting a first α,ω-dihydroxy compound having a formula of HO—Z—OH, and a second α,ω-dihydroxy compound having a formula of HO—Z′—OH, with i) an acid having a formula of Formula XI, ii) an ester of the acid having the formula of Formula XI, and/or iii) a cyclic anhydride of the acid having the formula of Formula XI. Z and Z′ can have a structure as described above. n can be 0 or 1, and denotes number of repeat units.

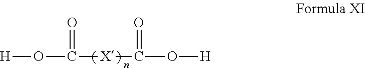

X′ can be an aliphatic group. X′ can contain up to 1000 carbon atoms. In some aspects, X′ can be a linear hydrocarbon. In some aspects, X′ can be a branched hydrocarbon In some aspects, X′ can be a polyolefin group. A polyolefin group of X′ can be a polyolefin with one H missing at each of the two ends of the polyolefin backbone chain, where the valency of the terminal carbons are satisfied by bonding with the “—COO—” groups at the two sides of X′. In some aspects, X′ can be a linear polyolefin group. In some aspects, X′ can be a branched polyolefin group having a DB of 0.01 to 50%. In some aspects. X′ can contain C₁ to C₁₀ hydrocarbon branches. In some aspects, X′ can be a polyethylene, poly(ethylene-propylene), poly(α-olefin), poly(α-olefin-co-ethylene), or poly(ethylene-co-α-olefin) group. In certain aspects, X′ can be a poly(ethylene-co-1-butene), poly(ethylene-co-1-hexene), or poly(ethylene-co-1-octene) group. In some aspects, X′ can be a polypropylene group, or a polybutylene group, or a poly(propylene-co-ethylene) group. In some aspects, X′ can be an atactic, isotactic, or syndiotactic polypropylene group. In some aspects, X′ can be random poly(propylene-co-ethylene) group. In certain aspects, X′ can contain 45 to 1000 carbon atoms. In certain aspects, X′ can be a C₁ to C₄₄ aliphatic group. In some particular aspects, X′ can be a C₁ to C₂₀ aliphatic group. In some aspects. X′ can be a linear or branched, and substituted or unsubstituted hydrocarbon. In some aspects, X′ can have the formula of (1), (6), (7), (8), or (9):

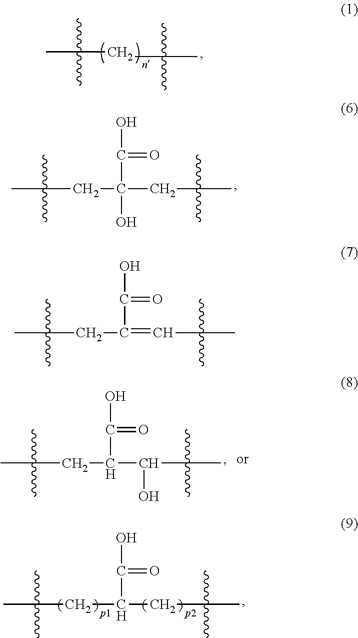

wherein n′ in formula (1) is an integer from 1 to 1000, and denotes number of repeat units, and wherein p1 and p2 in formula (9) are independently 0, 1, 2, 3, 4 or 5, and denote number of repeat units. In certain aspects, n′ is an integer from 1 to 15.

In some aspects, the acid (e.g., of Formula XI) can be oxalic acid, malonic acid, succinic acid, maleic acid, glutaric acid, adipic acid, pimelic acid, suberic acid, azelaic acid, sebacic acid, citric acid, aconitic acid, isocitric acid, propane-1,2,3-tricarboxylic acid, pentane-1,3,5-tricarboxylic acid, or any combinations thereof. In some aspects, the ester (e.g., of the acid of Formula (XI)) can be a methyl, ethyl and/or propyl ester. In some aspects, the cyclic anhydride can be malonic anhydride, succinic anhydride, maleic anhydride, glutaric anhydride, adipic anhydride, pimelic anhydride, suberic anhydride, azelaic anhydride, sebacic anhydride or any combinations thereof. In some aspects, the first and second α,ω-dihydroxy compounds can be reacted with the acid and/or ester and/or cyclic anhydride (e.g., of Formula XI) at i) a temperature of 90 to 250° C., and/or ii) under inert atmosphere and/or vacuum.

In some aspects, the acid and/or ester and/or cyclic anhydride thereof (e.g., of Formula XI) can be reacted with the first α,ω-dihydroxy compound, and the second α,ω-dihydroxy compound, in presence of a triol, tetraol, and/or polyol (poly>4). The triol, tetraol, and/or polyol can react with the acid and/or ester and/or cyclic anhydride thereof and form branches in the copolymer. The mole ratio of i) α,ω-dihydroxy compounds (total of first and second), and ii) total of triol, tetraol, and/or polyol, in the reaction mixture can be 9:1 to 100:1.

In some aspects, the method can include reacting the first α,ω-dihydroxy compound HO—Z—OH, and the second a, w-dihydroxy compound HO—Z′—OH with i) a first acid having the formula of Formula XI (and/or an ester, and/or cyclic anhydride thereof), and ii) a second acid having the formula of Formula XI (and/or an ester, and/or cyclic anhydride thereof), wherein X′ of the Formula XI of the first acid is different than the X′ of the Formula XI of the second acid. In some aspects, the X′ of the Formula XI of the first acid can be a linear hydrocarbon, and the X′ of the Formula XI of the second acid can contain one or more side functional groups. In some aspects, X′ of the Formula XI of the first acid has the formula of formula (1), and X′ the Formula XI of the second acid has the formula of formula (6), (7), (8), or (9). In some aspects, the first acid can be oxalic acid, malonic acid, succinic acid, maleic acid, glutaric acid, adipic acid, pimelic acid, suberic acid, azelaic acid, sebacic acid, or any combinations thereof. In some aspects, the second acid can be citric acid, aconitic acid, isocitric acid, propane-1,2,3-tricarboxylic acid, pentane-1,3,5-tricarboxylic acid, or any combinations thereof. In some aspects, the diacid can have 45 to 100 carbon atoms (e.g., 45, 50, 55, 60, 65, 70, 75, 85, 90, 95, 100 or any value or range there between) and a diol with less than 6 carbon atoms (e.g. 1, 2, 3, 4, 5, 6 or any value or range there between). A non-limiting example of a diol is ethylene glycol. In some aspects, the first and second α,ω-dihydroxy compound can be reacted with a) the first acid and/or ester and/or cyclic anhydride thereof and b) the second acid and/or ester and/or cyclic anhydride thereof at i) a temperature of 90 to 250° C., and/or ii) under inert atmosphere and/or vacuum.

Certain aspects are directed to a method for recycling a copolymer described herein. In some aspects, the recycling method can include depolymerization of the copolymer. In some aspects, the copolymer can be contacted water and/or an alcohol under conditions suitable to depolymerize the copolymer to produce i) a first α,ω-dihydroxy compound having a formula of HO—Z—OH, ii) a second α,ω-dihydroxy compound having a formula of HO—Z′—OH, and iii) an acid having a formula of Formula XI, and/or an ester thereof. The polymer can get depolymerized through hydrolysis (e.g. with water) and/or alcoholysis (e.g. with alcohol). In certain aspects, the polymer can be depolymerized by contacting the polymer with methanol to form the first and second α,ω-dihydroxy compound (e.g. HO—Z—OH and HO—Z′—OH) and a methyl ester of an acid having a formula of Formula XI. In certain aspects, the depolymerization conditions can include a temperature of 100° C. to 250° C. and/or a pressure of 10 barg to 60 barg.

In some aspects, the copolymer can be depolymerized to obtain i) the first α,ω-dihydroxy compound having a formula of HO—Z—OH, ii) the second a,w-dihydroxy compound having a formula of HO—Z′—OH, iii) the first acid having a formula of Formula XI, and/or an ester thereof, and iv) the second acid having a formula of Formula XI, and/or an ester thereof, wherein X′ of the Formula XI of the first acid is different than the X′ of the Formula XI of the second acid. In some aspects, the X′ of the Formula XI of the first acid can be a linear hydrocarbon, and the X′ of the Formula XI of the second acid can contain one or more side functional groups. In some aspects, X′ of the Formula XI of the first acid has the formula of formula (1), and X′ the Formula XI of the second acid has the formula of formula (6), (7), (8), or (9). In some aspects, the first acid can be oxalic acid, malonic acid, succinic acid, maleic acid, glutaric acid, adipic acid, pimelic acid, suberic acid, azelaic acid, sebacic acid, or any combinations thereof. In some aspects, the second acid can be citric acid, aconitic acid, isocitric acid, propane-1,2,3-tricarboxylic acid, pentane-1,3,5-tricarboxylic acid, or any combinations thereof.

In certain aspects, the first and second recycled α, ω-dihydroxy compounds obtained (e.g., through depolymerization) can be repolymerized to form a copolymer described herein. In certain aspects, the first and second recycled α,ω-dihydroxy compounds obtained (e.g., through depolymerization) can be repolymerized with an acid of Formula XI. In certain aspects, the first and second recycled α,ω-dihydroxy compounds obtained (e.g., through depolymerization) can be repolymerized with i) a first acid having the formula of Formula XI (and/or an ester, and/or cyclic anhydride thereof), and ii) a second acid having the formula of Formula XI (and/or an ester, and/or cyclic anhydride thereof), wherein X′ of the Formula XI of the first acid is different than the X′ of the Formula XI of the second acid.

Certain aspects are directed to a composition containing a copolymer described herein. In some aspects, the composition can further contain one or more additional components in addition to the copolymer. In some aspects, the composition can be comprised in or in the form of a foam, a fiber, a powder, a film, a layer, or a sheet. Certain aspects are directed to an article of manufacture containing a copolymer described herein and/or a composition containing the copolymer. The composition and/or article of manufacture can be molded, such as extruded, injection molded, blow molded, compression molded, rotational molded, thermoformed and/or 3-D printed article.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment discussed herein can be implemented with respect to any method or composition of the invention, and vice versa. Furthermore, compositions the invention can be used to achieve methods of the invention.

The following includes definitions of various terms and phrases used throughout this specification.

The term “degree of branching (DB)” of a group/oligomer/polymer refers to % of branched carbons in the backbone of the group/oligomer/polymer. For example, the following group having the formula of Formula (16), has a degree of branching 25%. The branched carbons in the backbone of the group of Formula 16 is marked with a*. R′ in formula 16 is a branching group, can be an alkyl group, and r is an integer and denotes number of repeat units.

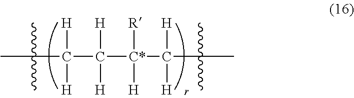

The term “linear hydrocarbon” refers to a hydrocarbon having a continuous carbon chain without side chain branching. The continuous carbon chain may be optionally substituted. The optional substitution can include replacement of at least one hydrogen atom with a functional group, such as hydroxyl, acid, amine, or halogen group; and/or replacement of at least one carbon atom with a heteroatom.

The term “branched hydrocarbon” refers to a hydrocarbon having a linear carbon chain containing branches, such as substituted and/or unsubstituted hydrocarbyl branches, bonded to the linear carbon chain. Optionally, the linear carbon chain can contain additional substitution. Optional additional substitutions can include replacement of at least one carbon atom in the linear carbon chain with a heteroatom and/or replacement of at least one hydrogen atom directly bonded to a carbon atom of the linear chain with a functional group, such hydroxyl, acid, amine, or halogen group.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol.%,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The polymer the present invention can “comprise,” “consist(s) essentially of,” or “consist of” particular groups, compositions, etc. disclosed throughout the specification. In one aspect of the present invention, and with reference to the transitional phrase “consist(s) essentially of” or “consisting essentially of,” a basic and novel characteristic of the present invention can include the copolymer containing repeating units of Formula I and repeating units of Formula II and/or can be chemically recycled to its building blocks or monomeric units in a relatively efficient manner (e.g., contacted with aqueous and/or alcohol solutions).

All publications mentioned herein are incorporated herein by reference to disclose and describe the methods and/or materials in connection with which the publications are cited.

Other objects, features and advantages of the present invention will become apparent from the following detailed description and examples. It should be understood, however, that the detailed description and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

In the context of the present invention, at least the following 23 aspects are described. Aspect I is directed to a copolymer comprising repeating units of Formula I, and repeating units of Formula II.

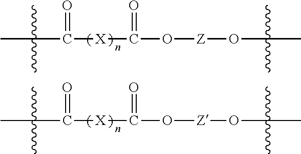

wherein,
n is independently 0 or 1 for each of Formula I and II, and denotes number of repeat units;
X is an aliphatic group for each of Formula I and II;
Z is a first polyolefin group comprising at least 45 carbon atoms, preferably 45 to 1,000 carbon atoms, and has a degree of saturation 98 to 100%; and
Z′ is a an aliphatic group,
wherein, the structure of Z is different than Z′.

Aspect 2 is directed to the copolymer of aspect 1, wherein Z and Z′ independently has a degree of branching (DB) of 0 to 50%.

Aspect 3 is directed to the copolymer of any one of aspects 1 to 2, wherein Z and/or Z′ independently comprises branches having independently 1 to 10 carbons.

Aspect 4 is directed to the copolymer of any one of aspects 1 to 3, wherein Z has a DB of 0 to less than 5% and Z′ has a DB of 5 to 50%.

Aspect 5 is directed to the copolymer of any one of aspects 1 to 4, wherein Z and/or Z′ are independently polyethylene, polypropylene, poly(ethylene-co-propylene), poly(ethylene-co-1-butene), poly(ethylene-co-1-hexene), or poly(ethylene-co-1-octene) group.

Aspect 6 is directed to the copolymer of any one of aspects 1 to 5, wherein Z and/or Z′ are independently an atactic, isotactic, or syndiotactic polypropylene.

Aspect 7 is directed to the copolymer of any one of aspects 1 to 6, wherein X for each of Formula I and II is independently

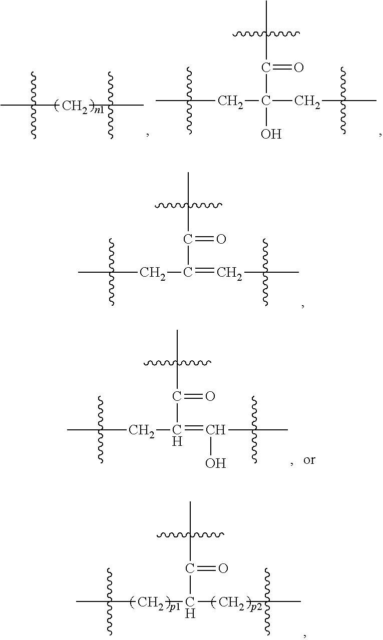

wherein n1 is independently an integer from 1 to 15 for each of Formula I and II, and denotes number of repeat units, p1 is independently 1, 2, or 3 for each of Formula I and II, and denotes number of repeat units, and p2 is independently 1, 2, or 3 for each of Formula I and II, and denotes number of repeat units.

Aspect 8 is directed to the copolymer of aspect 1, comprising repeating units of Formula III, and repeating units of Formula IV,

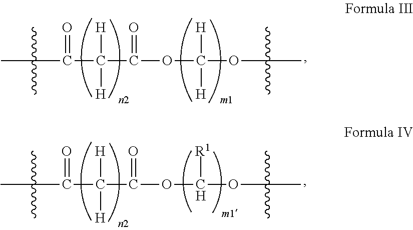

wherein n2 is independently an integer from 0 to 15 for each of Formulas III and IV, and denotes number of repeat units,

m1 is an integer from 45 to 1000, and denotes number of repeat units,

m1′ is an integer from 45 to 1000, and denotes number of repeat units,

R¹ is —H or —CH₂CH₃, and varies independently between —H and —CH₂CH₃ in the repeating units of —CHR¹—, and

the —(CHR')_{m1′}— group has a DB of 5 to 50%.

Aspect 9 is directed to the copolymer of aspect 1, comprising repeating units of Formula V, and repeating units of Formula VI,

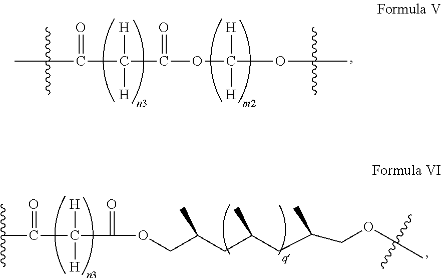

wherein n3 independently is an integer from 0 to 15 for each of Formulas V and VI, and denotes number of repeat units,

m2 is an integer from 60 to 600, and denotes number of repeat units, and

q′ is an integer from 100 to 225, and denotes number of repeat units.

Aspect 10 is directed to the copolymer of aspect 1, comprising repeating units of Formula VII, and repeating units of Formula VIII,

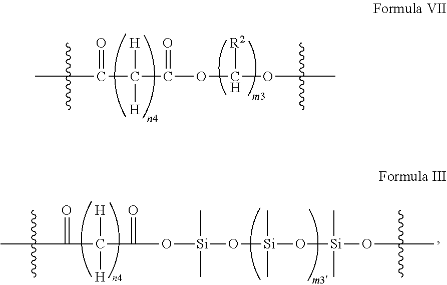

wherein n4 is independently an integer from 0 to 15 for each of Formulas VII and VIII, and denotes number of repeat units,

R² is —H or —CH₂CH₃, and varies independently between —H and —CH₂CH₃ in the repeating units of —CHR³—,

the —(CHR²)ₘ₃— group has a DB of 0.01 to 50%,

m3 is an integer from 60 to 600, and denotes number of repeat units, and

m3′ is an integer from 1 to 497, and denotes number of repeat units.

Aspect 11 is directed to the copolymer of aspect 1, comprising repeating units of Formula IX, and repeating units of Formula X,

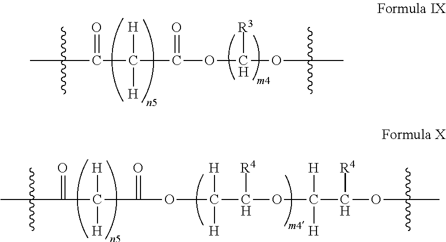

wherein n5 is independently an integer from 0 to 15 for each Formulas IX and X, and denotes number of repeat units,

R³ is —H or —CH₂CH₃, and varies independently between —H and —CH₂CH₃ in the repeating units of —CHR³—,

the —(CHR³)ₘ₄— group has a DB of 0.01 to 50%,

m4 is an integer from 60 to 600, and denotes number of repeat units,

m4′ is an integer from 1 to 332, and denotes number of repeat units, and

R⁴ is a C₂ to C₁₀ alkyl group.

Aspect 12 is directed to the copolymer of aspect 1, comprising repeating units of Formula XIV, and repeating units of Formula XV or XVI,

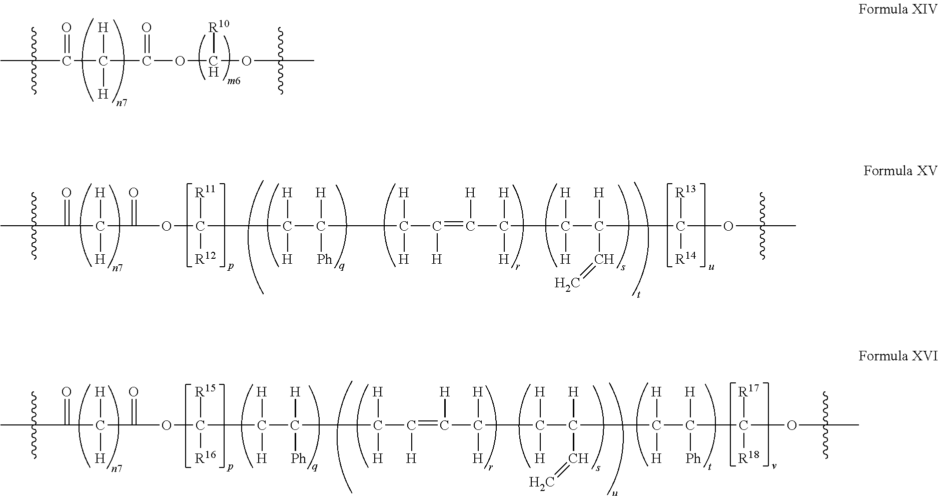

wherein n7 is independently an integer from 0 to 15 for each of Formula XIV, XV and XVI, and denotes number of repeat units,

m6 is an integer from 60 to 600, and denotes number of repeat units,

R¹⁰ is —H or a C₁ to C₁₀ alkyl group, and can vary independently between H and the C₁ to C₁₀ alkyl group in the repeating units of —CHR¹⁰—, the —(CHR¹⁰)ₘ₆—group has a DB of 0.01 to 50%,

R¹¹ is —H or a C₁ to C₁₀ alkyl group, and can vary independently between —H and the C₁ to C₁₀ alkyl group in the repeating units of —CR¹¹R¹²— group,

R¹² can be —H or a C₁ to C₁₀ alkyl group, and can vary independently between —H and the C₁ to C₁₀ alkyl group in the repeating units of —CR¹¹R¹²— group,

R¹³ can be —H or a C₁ to C₁₀ alkyl group, and can vary independently between —H and the C₁ to C₁₀ alkyl group in the repeating units of —CR¹³R¹⁴— group,

R¹⁴ can be —H or a C₁ to C₁₀ alkyl group, and can vary independently between —H and the C₁ to C₁₀ alkyl group in the repeating units of —CR¹³R¹⁴— group,

R¹⁵ can be —H or a C₁ to C₁₀ alkyl group, and can vary independently between —H and the C₁ to C₁₀ alkyl group in the repeating units of —CR¹⁵R¹⁶— group,

R¹⁶ can be —H or a C₁ to C₁₀ alkyl group, and can vary independently between —H and the C₁ to C₁₀ alkyl group in the repeating units of —CR¹⁵R¹⁶— group,

R¹⁷ can be —H or a C₁ to C₁₀ alkyl group, and can vary independently between —H and the C₁ to C₁₀ alkyl group in the repeating units of —CR¹⁷R¹⁸— group,

R¹⁸ can be —H or a C₁ to C₁₀ alkyl group, and can vary independently between —H and the C₁ to C₁₀ alkyl group in the repeating units of —CR¹⁷R¹⁸— group,

for Formula XV, p and u are independently an integer from 1 to 5; q, r, s, t are independently integers, wherein (q+r/2+s)×2×t≤1000−p−u, and for Formula XVI, p and v are independently an integer from 1 to 5; q, r, s, t, u are independently integers, wherein (q+(r/2+s)×u +t)×2<1000−p−v.

Aspect 13 is directed to the copolymer of any one of aspects 1 to 12, wherein the copolymer is a statistical copolymer.

Aspect 14 is directed to a method for forming the copolymer of any one of aspects 1 to 13, the method comprising:
reacting i) a first α,ω-dihydroxy compound having a formula of HO—Z—OH, and ii) a second α,ω-dihydroxy compound having a formula of HO—Z′—OH, with an acid or an ester or cyclic anhydride thereof, wherein the acid has the chemical formula of Formula XI

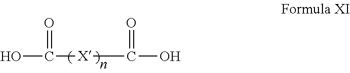

wherein n is 0 or 1, and denotes number of repeat units, and

wherein X′ is an aliphatic group.

Aspect 15 is directed to the method of aspect 14, wherein X′ is

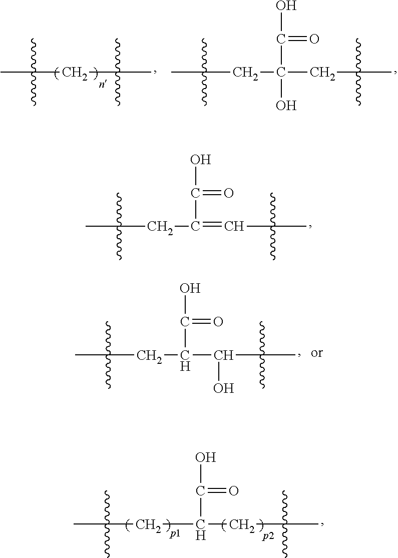

wherein n′ is an integer from 1 to 15, and denotes number of repeat units, and p1 and p2 are independently 1, 2, or 3, and denote number of repeat units.

Aspect 16 is directed to the method of aspect 14, wherein the acid is oxalic acid, malonic acid, succinic acid, maleic acid, glutaric acid, adipic acid, pimelic acid, suberic acid, azelaic acid, sebacic acid, citric acid, aconitic acid, isocitric acid, propane-1,2,3-tricarboxylic acid, pentane-1,3,5-tricarboxylic acid, or any combinations thereof.

Aspect 17 is directed to the method of any one of aspects 14 to 16, wherein the ester of the acid of HOOC—X′—COOH is a methyl, ethyl and/or propyl ester, and/or wherein the cyclic anhydride is malonic anhydride, succinic anhydride, maleic anhydride, glutaric anhydride, adipic anhydride, pimelic anhydride, suberic anhydride, azelaic anhydride, sebacic anhydride or any combinations thereof.

Aspect 18 is directed to the method of any one of aspects 14 to 17, wherein the reaction conditions include i) a temperature of 90 to 250° C., and/or ii) inert atmosphere and/or vacuum.

Aspect 17 is directed to a method for recycling a copolymer of any one of aspects 1 to 13, the method comprising contacting the polymer with water and/or an alcohol under conditions suitable to depolymerize the polymer through hydrolysis and/or alcoholysis to produce a first α,ω-dihydroxy compound having a formula of HO—Z—OH, a second α,ω-dihydroxy compound having a formula of HO—Z′—OH, and an acid having a formula of Formula XI, and/or an ester thereof,

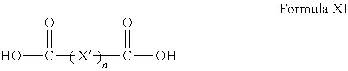

wherein n is 0 or 1, and denotes number of repeat units, and

wherein X′ is an aliphatic group.

Aspect 20 is directed to the method of aspect 19, wherein X′ is

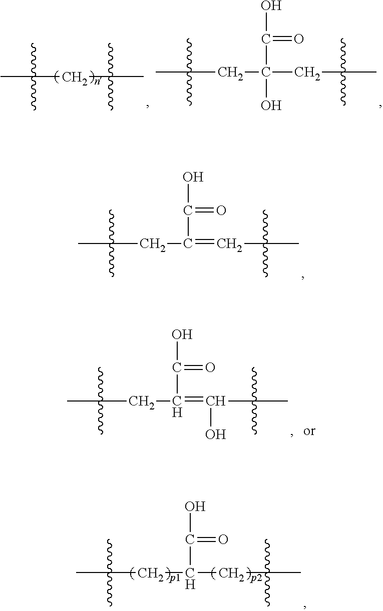

wherein n′ is an integer from 1 to 15, and denotes number of repeat units, and p1 and

p2 are independently 1, 2, or 3, and denote number of repeat units.

Aspect 21 is directed to a composition comprising a copolymer of any one of aspects 1 to 13.

Aspect 22 is directed to the composition of aspect 21, wherein the composition is comprised in an article of manufacture.

Aspect 23 is directed to the composition of aspect 22, wherein the article is an

injection molded, blow molded, compression molded, rotational molded, thermoformed and/or 3-D printed article.

### BRIEF DESCRIPTION OF THE DRAWINGS

Advantages of the present invention may become apparent to those skilled in the art with the benefit of the following detailed description and upon reference to the accompanying drawings.

FIG. 1 is the solid state NMR of a random olefin block copolymer of the present invention using α,ω-dihydroxy polyethylene (90 mol %), α,ω-dihydroxy hydrogenated polybutadiene-12% branching, and succinic acid.

FIG. 2 is the solid state NMR of a random olefin block copolymer of the present invention using α,ω-dihydroxy polyethylene (90 mol %), α,ω-dihydroxy hydrogenated polybutadiene-65% branching (10 mol %), and succinic acid.

FIG. 3 is the NMR of a random olefin block copolymer of the present invention using α,ω-dihydroxy polyethylene (60 mol %), α,ω-dihydroxy hydrogenated polybutadiene-65% branching (40 mol %), and succinic acid.

While the invention is susceptible to various modifications and alternative forms, specific embodiments thereof are shown by way of example in the drawings. The drawings may not be to scale.

### DETAILED DESCRIPTION OF THE INVENTION

A discovery has been made that may provide a solution to at least some of the problems associated with polyolefin polymers. In one aspect, the discovery can include providing a copolymer containing at least one block containing 0.01 to 40 ester groups per 1000 backbone carbons atoms, and having a degree of saturation higher than 97%. The copolymers of the current invention can have polyolefin like properties and can readily be recycled to the monomers of the polymers.

These and other non-limiting aspects of the present invention are discussed in further detail in the following sections.

### A. Copolymer

The copolymer can repeating units of Formula 1, and repeating units of Formula II:

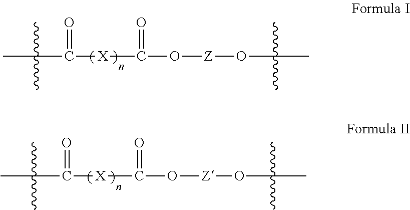

wherein n can independently be 0 or 1 in each of Formulas I and II, and denotes number of repeat units. In some aspects, the copolymer can contain additions units. The copolymer contains at least one block (e.g., Formula I and/or Formula II) containing 0.01 to 40 (e.g., 0.01, 0.1, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 or any value or range there between) ester groups per 1,000 backbone carbon atoms.

Z can be a polyolefin group. In certain aspects, Z can vary randomly between the repeating unitsof Formula I, such as number of carbon atoms and/or DB of the Z groups in the polymer can vary randomly. In certain aspects. Z does not vary between the repeating units of Formula I. In some aspects, Z can contain at least 45 carbon atoms. In some aspects, the polyolefin group of Z can contain 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In some aspects, average number of carbon atoms in the Z groups of the polymer can be 45 to 1000 or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, Z can have a degree of saturation 97 to 100%, or equal to any one of, at most any one of, or between any two 97, 97.5, 98, 98.5, 99, 99.5 and 100%. In some aspects, Z can be a linear polyolefin group. In some aspects, Z can be a linear polyolefin groups having the formula of Formula (10)

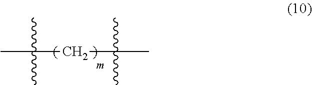

where m can be an integer from 45 to 1,000 or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000, and denotes number of repeat units. In some aspects, m can vary randomly between the repeating units of Formula 10, and/or average of m in the polymer, can be 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, m does not vary between the repeating units of Formula 10.

In some aspects, Z can be a branched polyolefin having a DB of 0.01 to 50%, or equal to any one of, at most any one of, or between any two 0.01, 0.1, 0.5, 1, 2, 3, 4, 4.5, 5, 6, 7, 8, 9, 10, 15, 20, 25, 30, 35, 40, 45 and 50%. In some aspects, Z can contain C₁ to C₁₀ branches (e.g. on the hydrocarbon backbone). In some aspects, Z can contain C₁ to C₁₀ alkyl group branches. In some aspects, the Z groups in the polymer can have an average DB of 0.01 to 10%, or equal to any one of, at most any one of, or between any two 0.01, 0.1, 0.5, 1, 2, 3, 4, 4.5, 5, 6, 7, 8, 9, 10, 15, 20, 25, 30, 35, 40, 45 and 50%.

In some aspects, Z can be a branched polyolefin group having the formula of Formula (11)

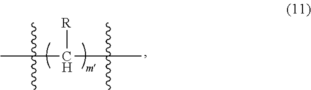

where, m′ can be an integer from 45 to 1000, and R can be —H or a C₁ to C₁₀ alkyl group, and varies independently between H and the C₁ to C₁₀ alkyl group in the repeating units —CHR—, wherein the —(CHR)_{m′}— group has a DB of 0.01 to 50%, or equal to any one of, at most any one of, or between any two of 0.01, 0.1, 1, 2, 3, 4, 4.5, 5, 6, 7, 8, 9, 10, 15, 20, 25, 30, 35, 40, 45 and 50%. In some aspects, m′ can be equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1000. For example, Formula (11a) is a non-limiting example of a polyolefin group with the formula (11), where R is —H or —CH₂CH₃, and R varies independently between —H and the —CH₂CH₃ in the repeating units —CHR—.

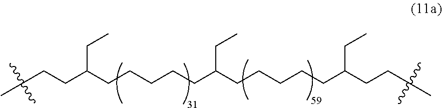

In some aspects, R can be —H or —CH₃. In some aspects, R can be —H or —CH₂CH₃. In some aspects, R can be —H or a C₃ alkyl group. In some aspects, R can be —H or a C₄ alkyl group. In some aspects, R can be —H or a C₅ alkyl group. In some aspects, R can be —H or a C₆ alkyl group. In some aspects, R can be —H or a C₇ alkyl group. In some aspects, R can be —H or a C₈ alkyl group. In some aspects, R can be —H or a C₉ alkyl group. In some aspects, R can be —H or a C₁₀ alkyl group. In some aspects, m′ can vary randomly between the repeating units of Formula 11, and/or average of m′s in the polymer can be, 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, m′ does not vary between the repeating units of Formula 11. In some aspects, DB of the —(CHR)_{m′} groups can vary randomly between the repeating units of Formula 11, and/or average DB of the —(CHR)_{m′}— groups in the polymer can be 0.01 to 50%, or equal to any one of, at most any one of, or between any two of 0.01, 0.1, 1, 2, 3, 4, 4.5, 5, 6, 7, 8, 9, 10, 15, 20, 25, 30, 35, 40, 45 and 50%. In some aspects, DB of the —(CHR)_{m′}— group does not vary between the repeating units of Formula 11.

In some aspects, the polyolefin group of Z can be a polyethylene, polypropylene, poly(ethylene-co-propylene), or poly(ethylene-co-α-olefin) group. In some aspects, α-olefin of the poly(ethylene-co-α-olefin) group of Z can independently be a propylene, 1-butene, 4-methyl-1-pentene, 1-hexene, styrene, vinylcyclohexane, 1-octene, norbornene, 5-vinyl-2-norbornene, 5-ethylidene-2-norbornene or 1-decene. In some aspects, Z can be a poly(ethylene-co-α-olefin) group containing less than 5 mol. % of α-olefin. In some aspects, Z can be a poly(ethylene-co-α-olefin) group containing 5 mol. %, or more than 5 mol. % of α-olefin.

The structure of Z can be different than Z′. Z′ can be an aliphatic group. In some aspects, Z′ can have a degree of saturation 97 to 100%, or equal to any one of, at most any one of, or between any two 97, 97.5, 98, 98.5, 99, 99.5 and 100%. In some aspects, Z′ can contain 1 to 1,000 carbon atoms, or equal to any one of, at least any one of, or between any two of 1, 2, 3, 4, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In some aspects, Z′ can have a degree of branching (DB) 0 to 50% or equal to any one of, at least any one of, or between any two of 0, 0.01, 0.1, 1, 3, 4.5, 5, 7, 10, 15, 20, 25, 30, 35, 40, 45 and 50%. In some aspects, Z′ can be a linear hydrocarbon. In some aspects, Z′ can be a branched hydrocarbon. In some aspects, Z′ can be a polyolefin group. In some aspects, Z′ can be a linear polyolefin group. In some aspects, Z′ can be a branched polyolefin group, having a DB of 0.01 to 50%. In some aspects, the branched polyolefin group of Z′ can contain C₁ to C₁₀ hydrocarbon branches. In some aspects, the branched polyolefin group of Z′ can contain C₁ to C₁₀ alkyl group branches. In some aspects, the polyolefin group of Z′ can be a polyethylene, polypropylene, poly(ethylene-co-propylene), or poly(ethylene-co-α-olefin) group. In some aspects, α-olefin of the poly(ethylene-co-α-olefin) group of Z′ can independently be a propylene, 1-butene, 4-methyl-1-pentene, 1-hexene, styrene, vinylcyclohexane, I-octene, norbornene, 5-vinyl-2-norbornene, 5-ethylidene-2-norbornene or 1-decene. In some aspects, Z′ can be a poly(ethylene-co-α-olefin) group containing less than 5 mol. % of α-olefin. In some aspects, Z′ can be a poly(ethylene-co-α-olefin) group containing 5 mol. %, or more than 5 mol. % of α-olefin. In some aspects, Z′ can be a linear polyethylene group. In some aspects, Z′ can be a branched polyethylene group containing C₁ to C₁₀ alkyl group branches, and a DB of 0.01 to 50%, such as 5 to 50%. In some aspects, Z′ can be an atactic, isotactic, or syndiotactic polypropylene group. In some aspects, Z′ can optionally contain one or more functional side groups. In some aspects, the one or more functional side groups can be one or more hydroxyl, acid, amine, or halogen groups. In some aspects, the functional groups can contain hydrocarbon groups linking the functional group to the hydrocarbon backbone of Z′.

In some aspects, Z and Z′ can be poly(ethylene-co-1-butene) groups where the mol. % of 1-butene in Z and Z′ are different. In some aspects, Z and Z′ can be poly(ethylene-co-1-octene) groups where mol.% of 1-octene in Z and Z′ are different. In some aspects, Z can be a linear or branched polyethylene group, and Z′ can be a poly(ethylene-co-1-butene) group. In some aspects, Z can be a linear or branched polyethylene group, and Z′ can be a poly(ethylene-co-1-octene) group. In some aspects, Z can be a poly(ethylene-co-α-olefin) group, and Z′ can be a polypropylene group.

In some aspects, Z′ can be a polyether group. The polyether group can contain 3 to 1,000 atoms, or equal to any one of, at least any one of, or between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900,) 50, and 1,000 atoms (e.g. carbon and oxygen atoms in total) in the polymer backbone. The polyether can be a linear or a branched polyether. The branched polyether can contain C₁ to C₁₀ hydrocarbon branches. In some aspects, the branched polyether can contain C₁ to C₁₀ alkyl group branches.

In certain aspects, the polyether can have the formula of formula (12)

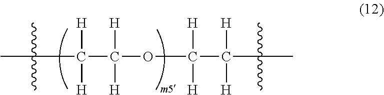

wherein m5′ is an integer from 1 to 332. and denotes number of repeat units. m5′ can be 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, m5′ can vary randomly between the repeating units of Formula 12, and/or average of mS's in the polymer can be, 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, m5′ does not vary in the repeating units of Formula 12.

In certain aspects, the polyether can have the formula of formula (13).

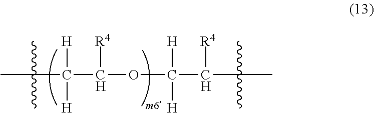

wherein m6′ is an integer from 1 to 332, and denotes number of repeat units. R⁴ can be C₁ to C₁₀ hydrocarbon. m6′ can be 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, the R⁴ can be —CH₃. In some aspects, R⁴ can be —CH₂CH₃. In some aspects, R⁴ can be a C₃ alkyl. In some aspects, R⁴ can be a C₄ alkyl. In some aspects, R⁴ can be a C₅ alkyl. In some aspects, R⁴ can be a C₆ alkyl. In some aspects, R⁴ can be a C₇ alkyl. In some aspects, R⁴ can be a C₈ alkyl. In some aspects, R⁴ can be a C₉ alkyl. In some aspects, R⁴ can be a C₁₀ alkyl. In some aspects, m6′ can vary randomly between the repeating units of Formula 13, and/or average of m6′s in the polymer can be, 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, m6′ does not vary in the repeating units of Formula 13.

In some aspects. Z′ can be a polydimethylsiloxane group. The polydimethylsiloxane group can contain 3 to 1000 atoms, or equal to any one of, at least any one of, or between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 atoms (e.g. silicon and oxygen atoms in total) in the polymer backbone. In some aspects, the polydimethylsiloxane group can have a formula of formula (14)

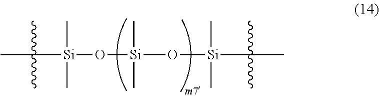

where m7′ is an integer from 1 to 497, or equal to any one of, at least any one of, or an integer between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380. 400, 420, 440, 460, 480, and 497, and denotes number of repeat units. In some aspects, m7′ can vary randomly between the repeating units of Formula 14, and/or average of m7′s in the polymer can be, 1 to 497, or equal to any one of, at least any one of, or an integer between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, and 497. In some aspects, m7′ does not vary in the repeating units of Formula 14.

In some aspects, Z′ can be a polystyrene, polybutadiene or styrene-butadiene copolymer group. In some aspects, Z′ can contain at least 45 carbon atoms, and can have a degree of saturation of the main chain of 60 to 100%, such as 75 to 100%. In some aspects, Z′ can contain 45 to 1,000 carbon atoms, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In some aspects, the polyolefin group of Z′ can be a polystyrene, polybutadiene, random poly(styrene-co-butadiene) or poly(styrene-block-polybutadiene) diblock copolymer or poly(styrene-block-polybutadiene-block-styrene) triblock copolymer group.

In some aspects, n can be 0, the copolymer can contain repeating units of Formula Ia, and repeating units of Formula IIa,

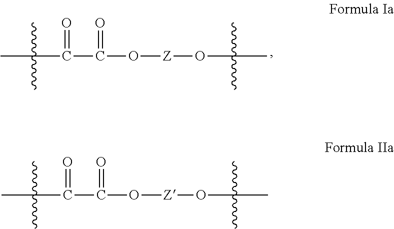

X in each of Formula I and Formula II can independently be an aliphatic group. X in each of Formula I and Formula II can independently contain up to 1000 carbon atoms or equal to any one of, at least any one of, or between any two of 1, 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 530, 600, 650, 700, 750, 800, 850, 900, 950, and 1,000 carbon atoms. In certain aspects, X in each of Formula I and Formula II can independently contain 45 to 1000 carbon atoms. In certain aspects. X in each of Formula I and Formula II can independently be a C₁ to C₄₄ aliphatic group. In some particular aspects. X in each of Formula I and Formula II can independently be an aliphatic group containing 1, 2, 3, 4, 5, 6, 7, 8, 9, 10, 11, 12, 13, 14, 15, 16, 17, 18, 19, or 20 carbons. In some aspects, X can be a linear or a branched hydrocarbon. In some aspects, X in each of Formula I and Formula II can independently be a branched hydrocarbon. In some aspects, X in each of Formula 1 and Formula II can independently be a polyolefin group. In some aspects, X in each of Formula I and Formula II can independently be a linear polyolefin group. In some aspects, X in each of Formula I and Formula II can independently be a branched polyolefin group having a DB of 0.01 to 50%, or equal to any one of, at least any one of, or between any two of 0.01, 0.1, 1, 2, 3, 4, 5, 6, 7, 8, 9, 10, 15, 20, 25, 30, 35, 40, 45 and 50%. In some aspects, X in each of Formula I and Formula II can independently contain C₁ to C₁₀ hydrocarbon branches. In some aspects, X in each of Formula I and Formula II can independently be a polyethylene, poly(ethylene-propylene), poly(α-olefin), poly(α-olefin-co-ethylene), or poly(ethylene-co-α-olefin) group. In certain aspects, X in each of Formula I and Formula II can independently be a poly(ethylene-co-1-butene), poly(ethylene-co-1-hexene), or poly(ethylene-co-1-octene) group. In some aspects, X in each of Formula I and Formula II can independently be a polypropylene group, or a polybutylene group, or a poly(propylene-co-ethylene) group. In some aspects, X in each of Formula I and Formula II can independently be an atactic, isotactic, or syndiotactic polypropylene group. In some aspects, X in each of Formula I and Formula II can independently be random poly(propylene-co-ethylene) group. In some aspects, the one or more side functional groups of X in each of Formula I and Formula II can independently be one or more of oxy, hydroxyl, acid, amine, or halogen groups. In some aspects, the functional groups can contain hydrocarbon groups linking the functional group to the backbone of X. In certain aspects, X can vary randomly between the repeating units of Formula I. In certain aspects, i) number of carbon atoms in the X groups can vary randomly between the repeating units of Formula I or iii) the DB of the X groups can vary randomly between the repeating units of Formula I. In certain aspects, X does not vary between the repeating units of Formula I. In certain aspects, X can vary randomly between the repeating units of Formula II. In certain aspects, i) number of carbon atoms in the X groups can vary randomly between the repeating units of Formula II or iii) the DB of the X groups can vary randomly between the repeating units of Formula II. In certain aspects, X does not vary between the repeating units of Formula II. In some aspects, average of number of carbon atoms in the X groups of the copolymer can be 1 to 1000 or equal to any one of, at least any one of, or between any two of 1, 2, 3, 4, 5, 6, 7, 8, 9, 10, 11, 12, 13, 14, 15, 16, 17, 18, 19, 20, 25, 30, 35, 40, 44, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, the X groups in the copolymer can have an average DB of 0.01 to 50%, or equal to any one of, at most any one of, or between any two 0.01, 0.1, 1, 2, 3, 4, 5, 6, 7, 8, 9, 10, 15, 20, 25, 30, 35, 40, 45 and 50%.

In some aspects, n can be 1, X can have the formula of Formula (1), and the copolymer can contain repeating units of Formula Ib, and repeating units of Formula IIb,

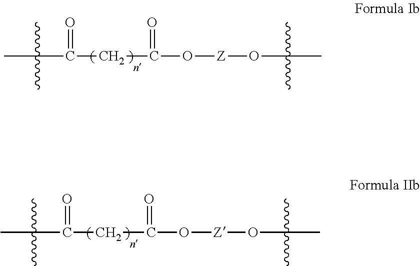

wherein n′ independently can be 1, 2, 3, 4, 5, 6, 7, 8, 9, 10, 11, 12, 13, 14 or 15, for each of Formula Ib and IIb, and denotes number of repeat units.

In some aspects, n can be 1, X can have the formula of Formula (2), and the copolymer can contain repeating units of Formula Ic, and repeating units of Formula IIc,

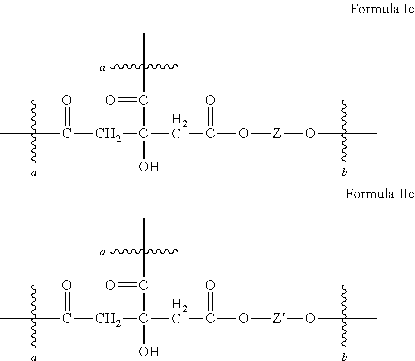

wherein the respective units are bonded through bonding between “a” and “b” ends.

In some aspects, o can be 1, X can have the formula of Formula (3), and the copolymer can contain repeating units of Formula Id, and repeating units of Formula IId,

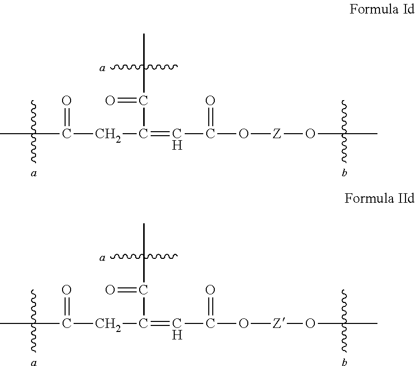

wherein the respective units are bonded through bonding between “a” and ends

In some aspects, n can be 1, X can have the formula of Formula (4), and the copolymer can contain repeating tits of Formula Ie, and repeating units of Formula IIe,

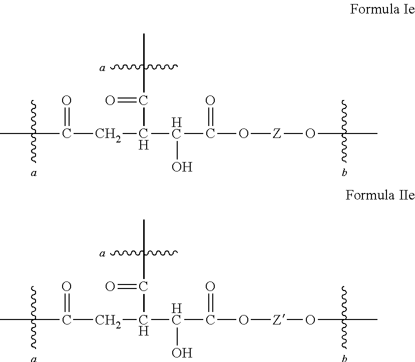

wherein the respective mits are bonded through bonding between “a” and “b” ends.

In some aspects, n can be 1, X can have the formula of Formula (5), and the copolymer can contain repeating units of Formula If, and repeating units of Formula IIf

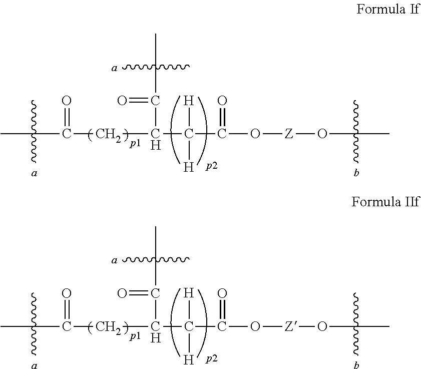

where the respective units are bonded through bonding between “a” and “b” ends. Formula (1)-(5) are described above.

In certain aspects, the copolymer can contain i) repeating units of a first unit having the formula of Formula I, and ii) repeating units of a second unit having the formula of Formula I, wherein X of the first unit can have a different formula than the X of the second unit. In certain aspects, X of the first unit can be a linear hydrocarbon, and the X of the second unit can contain one or more side functional groups. In some aspects, X of the first unit has the chemical formula of Formula (1), and X of the second unit has the chemical formula of Formula (2), (3), (4) or (5). The Z of the first unit and the second unit can be same or different, e. g. can have same or different chemical formula. In some aspects, Z of the first unit and the second unit can have the same formula. In certain aspects, the ratio of mol. % of the first unit and second unit in the copolymer can be 9:1 to 999:1, or equal to any one of, at least any one of, or between any two of 9:1, 10:1, 15:1, 20: 1, 25:1, 30:1, 35:1, 40:1, 45:1, 50: 1, 55:1, 60:1, 65:1, 70:1, 75:1, 80:1, 85:1, 90:1, 95:1, 100:1, 200:1, 300:1, 400:1, 500:1, 600:1, 700: 1, 800:1, 900:1, and 999:1. In certain aspects, the first unit can have formula of Formula Ib, and the second unit can have formula of Formula Ic, Id, Ie, and/or If.

In certain aspects, the copolymer can contain i) repeating units of a third unit having the formula of Formula II, and ii) repeating units of a fourth unit having the formula of Formula II, wherein X of the third unit can have a different formula than the X of the fourth unit. In certain aspects, X of the third unit can be a linear hydrocarbon, and the X of the fourth unit can contain one or more side functional groups. In some aspects, X of the third unit has the chemical formula of Formula (1), and X of the fourth unit has the chemical formula of Formula (2), (3), (4) or (5). The Z′ of the third unit and the fourth unit can be same or different, e. g. can have same or different chemical formula. In some aspects, Z′ of the third unit and the fourth unit can have the same formula. In certain aspects, the ratio of mol. % of the third unit and fourth unit in the copolymer can be 9:1 to 999:1, or equal to any one of, at least any one of, or between any two of 9:1, 10:1, 15:1, 20:1, 25:1, 30:1, 35: 1, 40: 1, 45:1, 50:1, 55:1, 60: 1, 65:1, 70:1, 75:1, 80:1, 85:1, 90: 1, 95:1, 100:1, 200:1, 300:1, 400:1, 500:1, 600: 1, 700: 1, 800:1, 900:1, and 999:1. In certain aspects, the third unit can have formula of Formula IIb, and the fourth unit can have formula of Formula IIc, IId, IIe, and/or IIf.

In some aspects, Tₘ of the polymer can be 40° C.to 180° C., or equal to any one of, at least any one of, or between any two of 40, 45, 50, 55, 60, 65, 70, 75, 80, 85, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 175 and 180° C. In some aspects, the number average molecular weight (Mₙ) of the copolymer can be 10,000 to 1,000,000 g/mol, or equal to any one of, at least any one of, or between any two of 10,000, 20,000, 40,000, 50,000, 60,000, 70,000, 80,000, 90,000, 100,000, 110,000, 120,000, 130,000, 140,000, 150,000, 160,000, 170,000, 180,000, 190,000, 200,000, 250,000, 300,000, 350,000, 400,000, 450,000, 500,000, 550,000, 600,000, 650,000, 700,000, 800,000, 900,000 and 1,000,000 g/mol, as determined as the polyethylene equivalent molecular weight by high temperature size exclusion chromatography performed at 160° C. in trichlorobenzene using polyethylene standards. In some aspects, the copolymer can have a polydispersity index (PDI), of 1.5-4.0, preferably 1.8 to 3.0, or equal to any one of, at least any one of, or between any two of 1, 1.1, 1.2, 1.3, 1.4, 1.5, 1.6, 1.8, 2, 2.2, 2.4, 2.6, 2.8, 3, 3.2, 3.4, 3.6, 3.8, and 4. In some aspects, the copolymer can be a statistical copolymer. In some aspects, the block copolymer can contain at least one amorphous block, and at least one semi-crystalline block. In some aspects, the block copolymer can contain at least two amorphous blocks, wherein the glass transition temperature (T_{g}) of the two blocks can be different.

In some aspects, the Z and Z′ groups in the copolymer can such that melt temperatures (Tm) of a polymer, such as a homopolymer, formed by the Z groups of the copolymer, and a polymer, such as a homopolymer, formed by the Z′ groups of the copolymer, can differ by at least 40° C., or by 40° C. to 180° C., such as 85° C. to 170° C., such as 90° C. to 150° C., or equal to any one of, at least any one of, or between any two of 40° C., 50° C., 60° C., 70° C., 80° C., 90° C., 100° C., 110° C., 120° C., 130° C., 140° C., 150° C., 160° C., 170° C., and 180° C. In some aspects, the melt temperatures (Tm) of a polymer such as a homopolymer, formed by the Z groups of the copolymer can be greater than can be equal to or greater than 40° C. Tm can be measured by differential scanning calorimetry performed at a heating rate of 10° C. per minute and wherein the melting temperature corresponds to the melting peak in the second run. In some aspects, the Z and Z′ groups in the copolymer can such that glass transition temperature (T_{g}) of a polymer, such as a homopolymer, formed by the Z groups of the copolymer, and a polymer, such as a homopolymer, formed by the Z′ groups of the copolymer, can differ by at least 5° C., such as by at least 10° C., such as by at least 20° C., such as by at least 30° C., such as by at least 40° C., such as by at least 50° C., such as by at least 100° C., such as at least by 140° C., or by 10 ° C. to 14° C., or equal to any one of, at least any one of, or between any two of 10° C., 20° C., 30° C., 40° C., 50° C., 60° C., 70° C., 80° C., 90° C., 100° C., 110° C., 120° C., 130° C., 140° C., 150° C., 160° C., 170° C., and 180° C. In some aspects, the Z and Z′ groups in the copolymer can such that crystallinity at room temperature of a polymer, such as a homopolymer, formed by the Z groups of the copolymer, and a polymer, such as a homopolymer, formed by the Z′ groups of the copolymer, can differ by at least 5%, such as by at least 10%, such as by at least 20%, such as by at least 30%, such as by at least 40%, such as by at least 50%. In certain aspects, a polymer, such as a homopolymer, formed by the Z groups of the copolymer, and the polymer, such as a homopolymer, formed by the Z′ groups of the copolymer can be crystalline at room temperature. In certain aspects, a polymer, such as a homopolymer, formed by the Z groups of the copolymer, and a polymer, such as a homopolymer, formed by the Z′ groups of the copolymer can be amorphous at room temperature. In certain aspects, a polymer, such as a homopolymer, formed by the Z groups of the copolymer can be amorphous, and the polymer, such as a homopolymer, formed by the Z′ groups of the copolymer can be crystalline at room temperature. In certain aspects, a polymer, such as a homopolymer, formed by the Z groups of the copolymer can be crystalline, and a polymer, such as a homopolymer, formed by the Z′ groups of the copolymer can be amorphous at room temperature. Crystallinity can be measured by X-ray powder diffraction (XRD).

### B. Method of Forming the Polymer

Certain aspects are directed to a method for forming a copolymer described herein. The method can include reacting a first α,ω-dihydroxy compound having a formula of HO—Z—OH, and a second α,ω-dihydroxy compound having a formula of HO—Z′—OH, with an i) acid having a formula of Formula XI, ii) an ester of the acid having the formula of Formula XI, and/or iii) a cyclic anhydride of the acid having the formula of Formula XI,

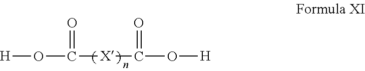

where n is 0 or 1, and denotes number of repeat units, and Z and Z′ are as described above.

X′ can be an aliphatic group. X′ can and/or on average contain up to 1000 carbon atoms, or equal to any one of, at most any one of, or between any two of 1, 10, 15, 20, 30, 40, 45, 50, 55, 60, 65, 70, 80, 90, 100, 150, 200, 220, 240, 260, 280, 300, 320, 340, 360, 380, 400, 420. 440, 460, 480, 500, 520, 540, 560, 580, 600, 650, 700, 750, 800, 850, 900, 950, and 1,000 carbon atoms. In certain aspects, X′ can contain 45 to 1000 carbon atoms. In certain aspects, X can be a C₁ to C₄₄ aliphatic group. In some particular aspects, X′ can be an aliphatic group containing 1, 2, 3, 4, 5, 6, 7 8, 9, 10, 11, 12, 13, 14, 15, 16, 17, 18, 19, or 20 carbons. In some aspects, X′ can be a linear or a branched hydrocarbon. In some aspects, X′ can be a branched hydrocarbon. In some aspects, X′ can be a polyolefin group. In some aspects, X′ can be a linear polyolefin group. In some aspects., X′ can be a branched polyolefin group having a DB of, and/or an average DB of 0.01 to 50%, or equal to any one of, at least any one of, or between any two of 0.01, 0.1. 1, 2, 3, 4, 5, 6, 7, 8, 9, 10, 15, 20, 25, 30, 35, 40, 45 and 50%. In some aspects, X can contain C₁ to C₁₀ hydrocarbon branches. In some aspects, X′ can be a polyethylene, poly(ethylene-propylene), poly(a-olefin), poly(α-olefin-co-ethylene), or poly(ethylene-co-α-olefin) group. In certain aspects. X can be a poly(ethylene-co-1-butene), poly(ethylene-co-1-hexene), or poly(ethylene-co-1-octene) group. In some aspects. X′ can be a polypropylene group, or a polybutylene group, or a poly(propylene-co-ethylene) group. In some aspects, X′ can be an atactic, isotactic, or syndiotactic polypropylene group. In some aspects, X′ can be random poly(propylene-co-ethylene) group. In some aspects, X′ can contain one or more side functional groups. In some aspects, the one or more side functional groups can be one or more of oxy, hydroxyl, acid, amine, or halogen groups. In some aspects, the functional groups can contain hydrocarbon groups linking the functional group to the backbone of X′. In some aspects, X′ can have the formula of formula (1), (6), (7), (8), or (9) or any combination thereof. In some aspects, a combination of acids, with different X′ can be used.

In some aspects, acids with different X′ can be used, providing a polymer where X varies, such as carbon atoms and/or DB of X varies, randomly between the repeating units of Formula I, and between the repeating units of Formula II. In some aspects, the acid (e.g. of Formula XI) can be oxalic acid, malonic acid, succinic acid, maleic acid, glutaric acid, adipic acid, pimelic acid, suberic acid, azelaic acid, sebacic acid, citric acid, aconitic acid, isocitric acid, propane-1,2,3-tricarboxylic acid, pentane-1,3,5-tricarboxylic acid, or any combinations thereof. In some aspects, the ester (e.g., of the acid having the formula of Formula XI) can be methyl, ethyl, propyl and/or tertiary butyl ester. In some aspects, the cyclic anhydride can be malonic anhydride, succinic anhydride, maleic anhydride, glutaric anhydride, adipic anhydride, pimelic anhydride, suberic anhydride, azelaic anhydride, sebacic anhydride or any combinations thereof. In some aspects, the HO—Z—OH, and HO—Z′—OH can be reacted with the acid or ester and/or cyclic anhydride (e.g., of Formula XI) at i) a temperature of 90 to 250° C., or equal to any one of, at least any one of, or between any two of 90, 100, 110, 120, 130, 140, 150, 160, 170, 180, 190, 200, 210, 220, 230, 240, and 250 ° C. and/or ii) under inert atmosphere and/or vacuum. In some aspects, the reaction can include esterification at 90 to 250° C., and/or under inert atmosphere, followed by polycondensation at 90 to 250° C., and/or under vacuum, e.g. at pressure below 0.5 mbar, such as below 0.1 mbar, such as around 0.05 mbar. In some aspects, HO—Z—OH can be reacted with the acid, ester and/or cyclic anhydride (e.g., of the acid of Formula XI) at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:05. In some aspects, HO—Z′—OH can be reacted with the acid, ester and/or cyclic anhydride (e.g. of the acid of Formula XI) at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:05. In some aspects, mole ratio of HO—Z—OH and HO—Z′—OH, during polymerization can be 5:95 to 95:5, or equal to any one of, at least any one of, or between any two of, 5:95, 10:90, 15:85, 20:80, 25:75, 30:70, 35:65, 40:60, 45:55, 50:50, 55:45, 60,:40, 65:35, 70:30, 75:25, 80:20, 85:15, 90:10, and 95:05.

In some aspects, the method can include reacting the first α,ω-dihydroxy compound HO—Z—OH, and the second α, ω-dihydroxy compound HO—Z′—OH with i) a first acid having the formula of Formula XI (and/or an ester, and/or cyclic anhydride thereof), and ii) a second acid having the formula of Formula XI (and/or an ester, and/or cyclic anhydride thereof), wherein X′ of the Formula XI of the first acid is different than the X′ of the Formula XI of the second acid. In some aspects, the X′ of the Formula XI of the first acid can be a linear hydrocarbon, and the X′ of the Formula XI of the second acid can contain one or more side functional groups. In some aspects, X′ of the Formula XI of the first acid has the formula of formula (1), and X′ of the Formula XI of the second acid has the formula of formula (6), (7), (8), or (9). In some aspects, the first acid can be oxalic acid, malonic acid, succinic acid, maleic acid, glutaric acid, adipic acid, pimelic acid, suberic acid, azelaic acid, sebacic acid, or any combinations thereof. In some aspects, the second acid can be citric acid, aconitic acid, isocitric acid, propane-1,2,3-tricarboxylic acid, pentane-1,3,5-tricarboxylic acid, or any combinations thereof. In some aspects, HO—Z—OH and HO—Z′—OH can be reacted with the a) first acid and/or ester and/or cyclic anhydride thereof, and b) the second acid and/or ester and/or cyclic anhydride thereof, at i) a temperature of 90 to 250° C., or equal to any one of, at least any one of, or between any two of 90, 100, 110, 120, 130, 140, 150, 160, 170, 180, 190, 200, 210, 220, 230, 240, and 250° C. and/or ii) under inert atmosphere and/or vacuum. In some aspects, the reaction (e.g. of HO—Z—OH and HO—Z′—OH with the first acid and/or ester and/or cyclic anhydride thereof, and the second acid and/or ester and/or cyclic anhydride thereof, can include esterification at 90 to 250° C., and/or under inert atmosphere, followed by polycondensation at 90 to 250° C., and/or under vacuum, e.g. at pressure below 0.5 mbarg, such as below 0.1 mbarg, such as around 0.05 mbarg. In some aspects, HO—Z—OH can be reacted with the first acid, ester and/or cyclic anhydride (e.g., of the acid of Formula XI) at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60,:40, 65:35, 70:30, 75:25, 80:20, 85:15, 90:10, and 95:05. In some aspects, HO—Z′—OH can be reacted with the first acid, ester and/or cyclic anhydride (e.g. of the acid of Formula XI) at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:05. In some aspects, mole ratio of HO—Z—OH and HO—Z′—OH, during polymerization can be 5:95 to 95:5, or equal to any one of, at least any one of, or between any two of, 5:95, 10:90, 15:85, 20:80, 25:75, 30:70, 35:65, 40:60, 45:55, 50:50, 55:45, 60,:40, 65:35, 70:30, 75:25, 80:20, 85:15, 90:10, and 95:05. The first acid and the second acid can be reacted with the HO—Z—OH and HO—Z′—OH at a first acid: second acid mole ratio of 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95: 1, 100:1, 200:1, 300:1, 400:1, 500:1, 600:1, 700:1, 800:1, 900:1, and 999:1. In certain aspects, the compounds HO—Z—OH and HO—Z′—OH can be polymerized with more than two acids selected from oxalic acid, malonic acid, succinic acid, maleic acid, glutaric acid, adipic acid, pimelic acid, suberic acid, azelaic acid, sebacic acid, citric acid, aconitic acid, isocitric acid, propane-1,2,3-tricarboxylic acid, and pentane-1,3,5-tricarboxylic acid, and/or esters, and/or anhydride thereof.

In some aspects, the acid and/or ester and/or cyclic anhydride thereof (e.g., of Formula XI) can be reacted with the first α,ω-dihydroxy compound, and the second α,ω-dihydroxy compound, in presence of a triol, tetraol, and/or polyol (poly >4). The triol, tetraol, and/or polyol can react with the acid and/or ester and/or cyclic anhydride thereof and form branches in the copolymer. The mol. ratio of i) the first and second α, ω-dihydroxy compounds, and ii) triol, tetraol, and/or polyol, in the reaction mixture can be 9:1 to 100:1 or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, and 100:1. In some aspects, the triol or tetraol can be glycerol, trimethalolmethane, trimethalolethane, trimethalolpropane, 3-hydroxymethyl-1,5-pentanediol, pentaerythritol, or any combinations thereof.

In certain aspects the reaction, (e.g., esterification and/or polycondensation) can be performed in presence of a catalyst. In some aspects, catalyst used can include but are not limited to a mineral acid, organic acid, organic base, metallic compound and/or enzymes. In some aspects, the metallic compounds can be a hydrocarbyl, oxide, chloride, carboxylate, alkoxide, aryloxide, amide, salen complex, β-ketiminato complex, or guanidinato complex, of a metal. In some aspects, the metal can be Li, Na, K, Mg, Ca, Sc, Y, lanthanides, Ti, Zr, Zn, Mo, Mn, Al, Ga, Bi, Sb, or Sn. In some aspects, the catalyst can be Ti(OiPr)₄, Ti(OBu)₄, Al(OiPr)₃, Sn(2-ethyl-hexanoate)₂, MoO₃, or any combinations thereof. In certain aspects, a combination of catalyst can be used.

In non-limiting examples, Schemes VI through XI show various diols that can be polymerized with succinic acid to form copolymers of the present invention. In Scheme VI, diols (15) and (16), where x, y, z are mole fraction, can be polymerized with succinic acid to form the copolymer (17) that can contain a1 and a2 units arranged randomly.

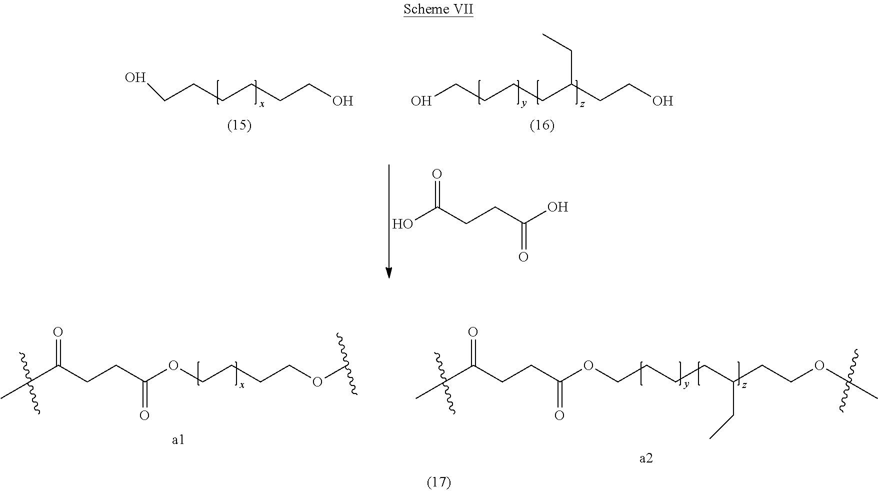

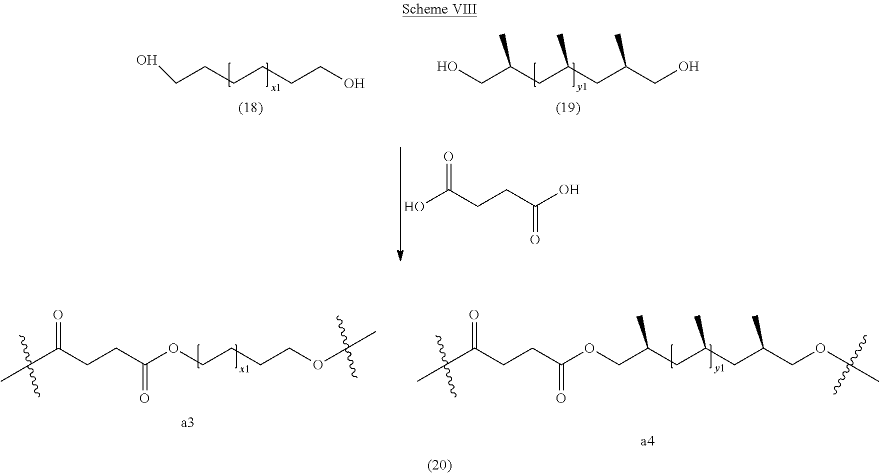

As shown in Scheme IX, diols (21) and (22), where x3, y3, and z3 are mole fraction and R⁵ is a C1 to C10 alkyl group, can be polymerized with succinic acid to form the copolymer (23) of the present invention that can contain a5 and a6 units arranged randomly.

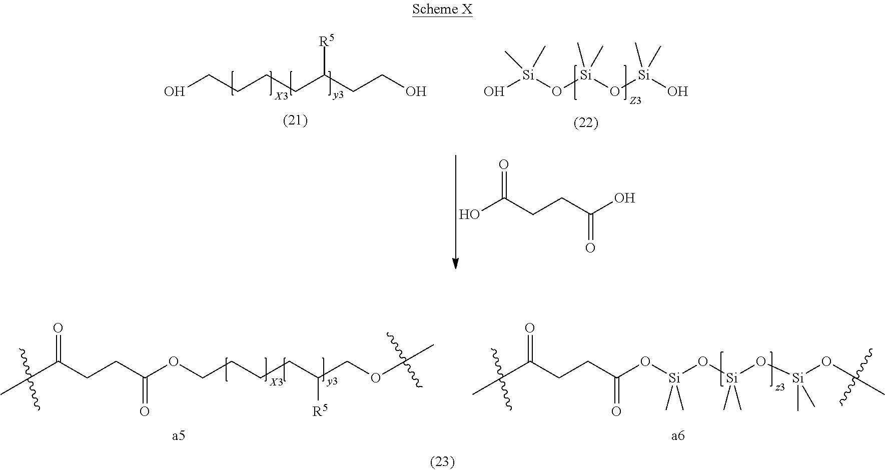

As shown in Scheme XL, diols (24) and (25), wherex4, y4, and z4 are mole fraction and R⁶ and R⁷ are independently a C1 to C10 alkyl group, can be polymerized with succinic, acid to fon dre copolymer (26), that contains as and ac units arranged randomly.

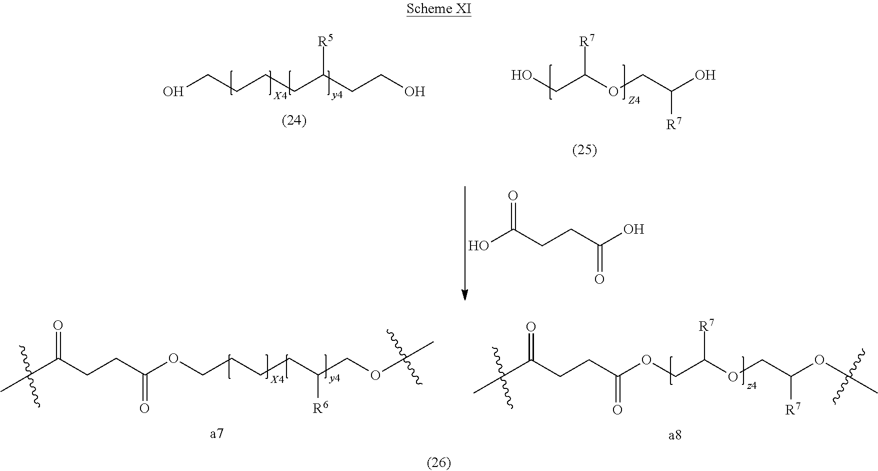

### C. Method of Recycling the Polymer

Certain aspects of the present invention are directed to a method of recycling a copolymer described herein. The recycling can include depolymerizing the copolymer. The copolymer can be depolymerized to obtain a first α,ω-dihydroxy compound having a formula of HO—Z—OH and a second α,ω-dihydroxy compound having a formula of HO—Z′—OH. In certain aspects, the depolymerization method can include hydrolysis and/or alcoholysis of the copolymer to obtain the compound of formula HO—Z—OH, HO—Z′—OH and the acid of Formula XI (e.g., via hydrolysis), and/or an ester of the acid of Formula XI (e.g., via alcoholysis). In certain aspects, the depolymerization method can include methanolysis of the copolymer under conditions suitable to obtain a compound of formula HO—Z—OH, HO—Z′—OH, and a methyl ester of an acid of Formula XI.

In certain aspects, the depolymerization of the copolymer can produce i) the compound HO—Z—OH, ii) the compound HO—Z′—OH, iii) a first acid having a formula of Formula XI (e.g., via hydrolysis), and/or an ester thereof (e.g., via alcoholysis), and iv) a second acid having the formula of Formula XI (e.g., via hydrolysis) and/or an ester thereof (e.g., via alcoholysis), wherein X′ of the Formula XI of the first acid is different than the X′ of the Formula XI of the second acid. In some aspects, the X′ of the Formula XI of the first acid can be a linear hydrocarbon, and the X′ of the Formula XI of the second acid can contain one or more side functional groups. In some aspects, X′ of the Formula XI of the first acid has the formula of formula (1), and X′ of the second acid has the formula of formula (6), (7), (8), or (9). In some aspects, the first acid can be oxalic acid, malonic acid, succinic acid, maleic acid, glutaric acid, adipic acid, pimelic acid, suberic acid, azelaic acid, sebacic acid, or any combinations thereof. In some aspects, the second acid can be citric acid, aconitic acid, isocitric acid, propane-1,2,3-tricarboxylic acid, pentane-1,3,5-tricarboxylic acid, or any combinations thereof.

In some aspects, the methanolysis conditions can include i) a temperature of 100° C. to 250° C., or equal to any one of, at least any one of, or between any two of 100, 110, 120, 130, 140, 150, 160, 170, 180, 190, 200, 210, 220, 230, 240, and 250° C. and/or ii) a pressure of 10 barg to 60 barg, or equal to any one of, at least any one of, or between any two of 10, 15, 20, 25, 30, 35, 40, 45, 50, 55 and 60 barg. In some aspects, the depolymerization can be performed at an inert atmosphere. Catalyst used for depolymerization, such as methanolysis can include a mineral acid, organic acid, organic base, and/or metallic compound. In some aspects, the metallic compounds can be a hydrocarbyl, oxide, chloride, carboxylate, alkoxide, aryloxide, amide, salen complex, B-ketiminato complex, or guanidinato complex, of a metal. In some aspects, the metal can be Li, Na, K, Mg, Ca, Sc, Y, lanthanides, Ti, Zr, Zn, Mo, Mn, Al, Ga, Bi, Sb, or Sn. In some aspects, the catalyst can be Ti(OiPr)₄, Ti(OBu)₄, Al(OiPr)₃, Sn(2-ethyl-hexanoate)₂, MoO₃, or any combinations thereof.

In certain aspects, the method of recycling can include repolymerization of the recycled HO—Z—OH and/or HO—Z′—OH, e.g., obtained from the depolymerization process. The recycled HO—Z—OH and/or HO—Z′—OH can be repolymerized to form a copolymer described herein. In some aspects, the recycled HO—Z—OH and/or HO—Z′—OH can be repolymerized with an acid having the formula of Formula XI, an ester, and/or cyclic anhydride thereof (e.g., of acid of Formula XI). In some aspects, the recycled HO—Z—OH and/or HO—Z′—OH can be repolymerized with a first acid an ester, and/or cyclic anhydride thereof, and a second acid an ester, and/or cyclic anhydride thereof.

### D. Compositions and Article of Manufacture Containing the Polymer

The copolymer described herein can be included in a composition. In some aspects, the composition can contain a blend of the copolymer and one or more other polymers. In some aspects, the one or more other polymers can be polyethylene, polypropylene, EPDM, polystyrene, polyethylene terephthalate, polybutylene terephthalate, polyvinyl chloride, polyvinyl acetate, ethyl vinyl alcohol (EVOH), ethylene-vinyl acetate (EVA), polymethyl methacrylates, polyacrylates, polycarbonates, polysulphonates, polyurethanes, polyamides, synthetic rubber, bitumen, mineral oils, or any combinations thereof. In some aspects, the composition can further include one or more additives. The one or more additives may include, but are not limited to, a scratch-resistance agent, an antioxidant, a flame retardant, an UV absorber, a photochemical stabilizer, a filler such as glass and/or mineral filler, an optical brightener, a surfactant, a processing aid, a mold release agent, a pigment, flow modifiers, foaming agents or any combinations thereof. In some aspects, the compositions can be comprised in or in the form of a foam, a film, a layer, a sheet, a molded article, a welded article, a filament, a fiber, a wire, a cable, or a powder. In one example, the composition is incorporated into a film. Specifically, the film may include at least one film layer that includes the composition. In further aspects the film includes at least a second film layer.

Certain aspects are directed to an article of manufacture containing a copolymer described herein and/or a composition containing the copolymer. The composition and/or article of manufacture can be molded, such as extruded, injection molded, blow molded, compression molded, rotational molded, thermoformed and/or 3-D printed article. In some aspects, the article of manufacture can be a personal equipment part, an automobile part, plumbing material, construction material, a consumer electronics housing, a personal equipment part, a kitchen appliance, furniture, or a home appliance component.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results. Inventors these are prophetic examples, if possible please provide preferred values (can be small ranges) of the mole fractions (e.g. x, y and z in example 1), mol. wt. of the diols, etc. required to achieve the desired (e.g. hard-soft) copolymers.

### Example 1

### Synthesis of Unsaturated Branched Diol

A multistep synthesis was performed to produce an unsaturated branched polybutadiene diol of the invention. Prior to polymerization, all the glassware were carefully oven dried and charged with argon. All experiments were performed in an inert controlled atmosphere.

Instrumentation. Thermal analysis was carried out on a DSC Q100 from TA Instruments at a heating rate of 10° C. per minute. First and second runs were recorded after cooling down to about −40° C. The melting temperatures reported correspond to second runs.

Step 1. Synthesis of a hydroxy end group on polybutadiene is shown in (Scheme I). 1,3-Butadiene solution (13.33 g, 36.97 mmol of 15 wt % solution in n-hexane) was added to a reactor under argon atmosphere. Then t-BDMSOPrLi solution (1 mL, 0.5 mmol of 0.5 mol/L see above for analysis method) was added to the reaction mixture under stirring. After complete addition, the reaction mixture was heated to 50° C. and stirred at this temperature for 5 hours. After 5 hours, the reaction mixture was cooled to room temperature and ethylene oxide (15.6 mL, 12.5 mmol of 0.8 mol/L in hexane) was added and allowed the reaction mixture to stir for another 2 h at room temperature. Finally, the reaction mixture was terminated by the addition of degassed (degassing done by freeze-pump-thaw method) methanol (1.5 mL) to form hydroxy end group in polybutadiene. The solution was concentrated and precipitated into an excess of methanol to obtain polybutadiene with one hydroxy end group as a white viscous liquid.

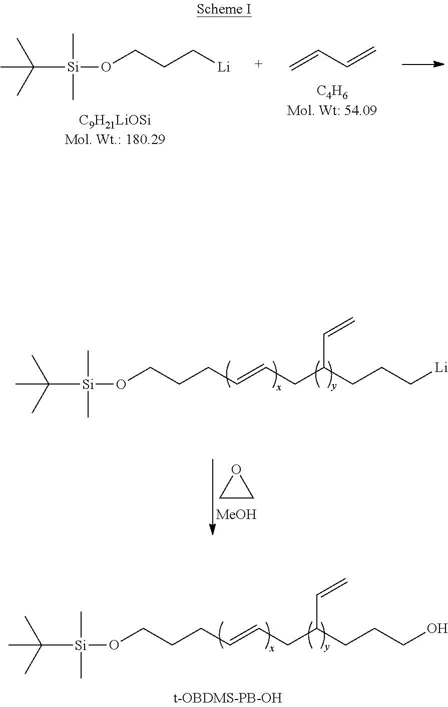

Step 2: Synthesis of dihydroxy terminated polybutadiene is shown in Scheme II. The polybutadiene (1 g) made in Step 1 with one hydroxy end group) was dissolved in THF (10 mL). Subsequently, excess tetrabutylammonium fluoride (TBAF, 1 M in THF); was added to the solution ([TBAF]/[TBDMS] 3:1 weight ratio) at room temperature under stirring and allowed to react for 24 h to obtain the hydroxyl groups at both ends of the polybutadiene. Finally, the polymer was precipitated in methanol and residual solvent was evaporated. The crude product was dissolved in 50 mL of suitable solvent (according to its solubility, either in hexane/cyclohexane/dichloromethane) and washed with water (2×50 mL) to remove any salts present in the crude mixture. The solvent was dried over anhydrous sodium sulfate (˜10 g), filtered and the solvent was evaporated using a rotary evaporator to produce unsaturated OH—PB—OH.

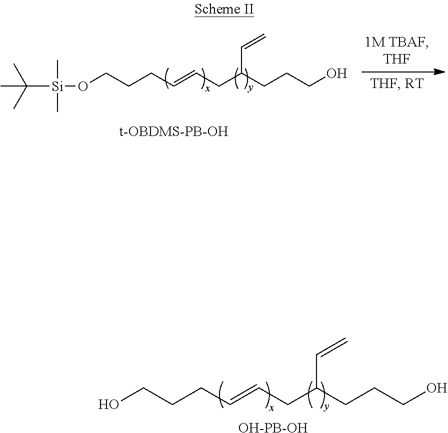

Step 3: Hydrogenation of unsaturated OH—PB—OH is shown in Scheme III. In a 600 mL Parr vessel, transfer/weigh unsaturated OH—PB—OH (24 gm Mw-5500) into a conical flask and add cyclohexane (150 ml) into the conical flask. Mix the contents in the conical flask thoroughly and then transfer the contents into the Parr vessel. Add additional cyclohexane (150 ml) into the conical flask. Mix the contents in the conical flask thoroughly and then transfer the contents into the Parr vessel. (Ensure that no reactant is present in the conical flask). Add Pd/CaCO₃ (2.4 g of 3 wt. %) catalyst directly into the Parr vessel. The Parr vessel was sealed and heated to 75° C. at 60 barg (0.6 MPa) until the unsaturated OH—PB—OH was hydrogenated to greater than 99.5% to form saturated OH—PB—OH.

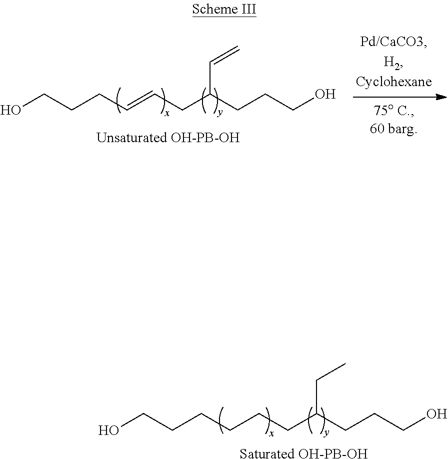

### Example 2

### Synthesis of an Unsaturated Linear Diol

The linear diol (for α,ω-dihydroxy polyethylene) was synthesized as shown in Scheme IV. In step 1, cis-1,4-diacetoxy-2-butene (2.07 g, 61 12.0 mmol) was added to THF (135 mL) in a two-neck 500 mL Schlenk flask under argon purging. The flask was then transferred to a 35° ° C. oil bath, and cis-cyclooctene (30 g, 272.2 63 mmol) was added dropwise over 30 min. The addition of a second generation Grubbs catalyst (101.86 mg, 0.12 mmol) solution in THF (3 mL) was started after adding 1 mL cis-cyclooctene. After 6 hours of reaction, the mixture was precipitated into acidic methanol (1.2 L with 35% HCl (1.5 g) solution in water (13.5 g). The precipitated polymer, α,ω-diacetoxy terminated polycyclooctene was collected and dried under vacuum for two days.

In step 2, the end acetoxy groups in α,ω-diacetoxy terminated polycycloocene were converted into hydroxy groups. The polymer of step 1 above was dissolved in THF (137.5 mL) at 40° C. and 25 wt % NaOMe (2.97 g, 55.0 mmol) solution in methanol was added. The solution was stirred for 20 hours and precipitated into methanol (272 L) with 35% HCl (1.5 g) solution in water (13.5 g). The isolated α,ω-dihydroxy polycyclooctene (HO-PCOE-OH) was dried under vacuum.

In step 3, the α,ω-dihydroxy polycyclooctene (HO-PCOE-OH) was hydrogenated. HO-PCOE-OH, (10 g, 90.7 mmmol double bonds), p-toluenesulfonyl hydrazide (52.4 g, 281.3 mmol), tributylamine (75.6 mL, 317.6 mmol), butylated hydroxytoluene (50 mg, 0.22 mmol), and o-xylene (385.76 mL) were added to a 1000 mL three-neck round-bottom flask. The mixture was heated to 140° C. and refluxed for 6 hours. After cooling to room temperature, the reaction mixture was poured into methanol. The obtained precipitate was washed with methanol (2× 500 mL). The isolated white powder was dried under vacuum the extent of hydrogenation was determined by ¹H-NMR and found to be >99%. 1H-NMR of (TCE-d2, ≥99.5 atom % D, 120° C.: δ: 3.66 (t, CH₂—OH, a′); b); 1.61-1.24 (m, —CH₂—). DSC data of α,ω-dihydroxy polyethylene showed a Tₘ and T_{c} of 129° C., 117° C. respectively. TGA in N₂ atmosphere was found to be 452° C.

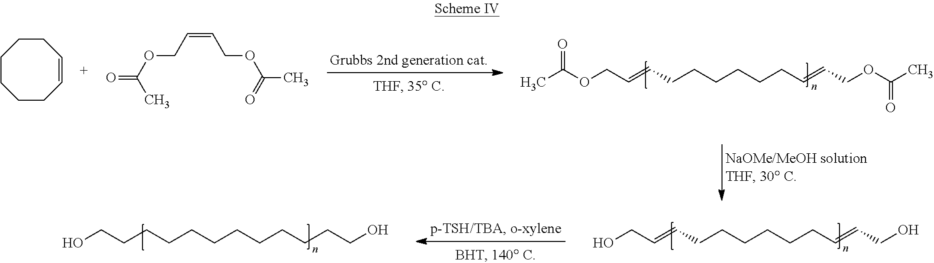

### Example 3

### Random Olefin Block Copolymer Synthesis of the Present Invention Using Diols From Examples 1 and 2 and Succinic Acid

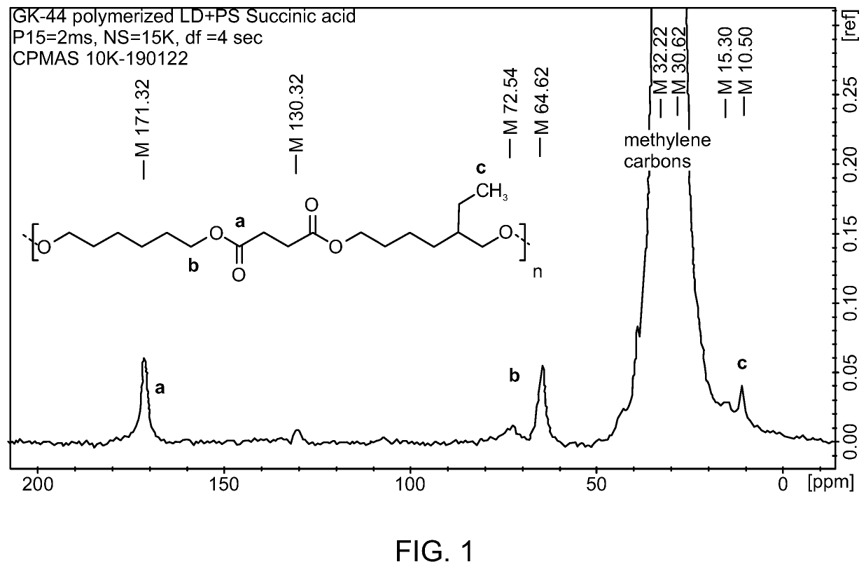

Random olefin block copolymer synthesis using α,ω-dihydroxy polyethylene (90 mol %, MW 3000, Example 2) , α,ω-dihydroxy hydrogenated polybutadiene-12% branching (10 mol %, MW 8500, Example 1) and succinic acid (MW 118, Aldrich) is shown in Scheme V. α,ω-Dihydroxy polyethylene (15.4 g, 8.64 mmol), α,ω-dihydroxy hydrogenated polybutadiene (3.2 g, 0.96 mmol), succinic acid (1.13 g, 9.6 mmol), and titanium tetra-isopropoxide (0.24 g) were introduced into the reactor and the reactor was then heated to 190° C. under stirring and in the presence of a nitrogen atmosphere. The first stage, esterification was carried out for 2.5 hrs at atmospheric pressure. After that, the second stage, polycondensation was started by turning off the nitrogen and by gradually reducing the pressure down to ˜0.05 mbar and the temperature was raised to 220° C. After polycondensation reaction for 3.0 hrs, the vacuum was released by bleeding in the Nitrogen and the polymer was collected. DSC data of the random olefin block copolymer showed a Tm and Tc of 123° C., 104° C. respectively. TGA in a nitrogen atmosphere was found to be 454° C. The random olefinic block copolymer was characterized by solid state nuclear magnetic resonance (SSNMR) (FIG. 1) XRD pattern was that of a of random OBC and the % crystallinity was found to be 66.4% with peaks characteristics peaks of polyethylene at 2θ≈21.70 and 2θ≈24.10 due to 110 and 200 reflections.

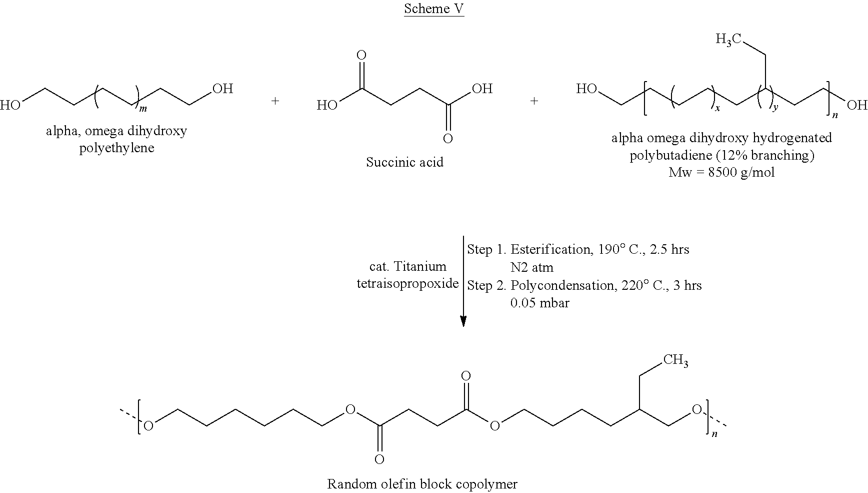

The olefin block co-polymer mimics (OBC polymer mimic of the present invention) in this Example was made by a hard block which is a linear diol with molecular weight of 3000 g/mol and was fully hydrogenated (linear 90 mol %) and soft block (10%) which had molecular weight of 8500 g/mol; with degree of branching 12 mol %. Branching carbon chain length of 2 (2 carbon atoms; vinyl) along with linker which is succinic acid (a di-carboxylic acid) via esterification and condensation reaction. The OBC-mimic (olefin block co-polymer mimic of the present invention) was highly crystalline (˜66.4%) and had melting temperature Tₘ˜122° C. It was observed that the crystallinity and melting temperature were controlled by the hard (linear) block and the elastomeric property was governed by the soft (branched) block.

The results showed that the copolymer made in accordance to the present invention was a block copolymer having two polyolefin groups that were different from each other and linked by ester groups. One of the polyolefin groups was aliphatic and the other polyolefin group was branched. Each polyolefin group had a degree of saturation of 98% (within the range of 98% to 100%) and 212 carbon atoms (at least 100 carbon atoms). The branched group had a degree of branching that was 12% (within the range of 0.01 to 50%).

### Example 4

### Random Olefin Block Copolymer Synthesis Using the α,ω-Dihydroxy Polyethylene, a Commercial Branched Diol, and Succinic Acid)

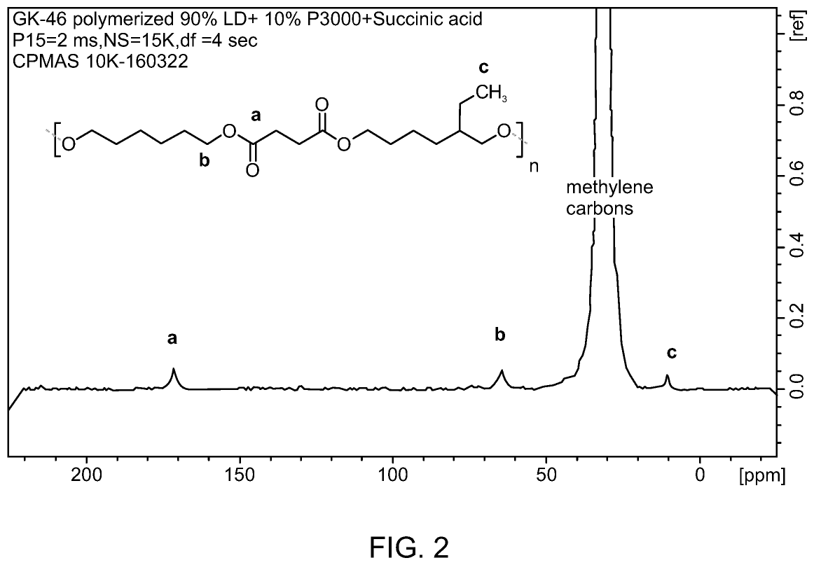

Commercial diol (MW=3000, Mn=3100, KRASOL HLBH P 3000, 65% branching, Cray Valley) was hydrogenated in the same manner as described in step 3 of Example 1 to produce a hydrogenated branched diol (65% branching, hydrogenation <99%). α,ω-Dihydroxy polyethylene was synthesized in the same manner as Example 2 to produce α,ω-dihydroxy polyethylene (90) mol %, MW 3000). Random olefin block copolymer synthesis was performed with the α,ω-dihydroxy polyethylene (90 mol %), hydrogenated branched diol (10 mol %, −65% branching) and succinic acid. α,ω-Dihydroxy hydrogenated polybutadiene (10.2 g, 5.8 mmol), the hydrogenated branched diol (1.16 g, 0.64 mmol), succinic acid (0.76 g, 6.44 mmol), and titanium tetra-isopropoxide (0.16 g) were introduced into the reactor and the reactor was then heated to 190° C. under stirring and in the presence of nitrogen atmosphere. The first stage, esterification was carried out for 2.5 hrs at atmospheric pressure. After that, the second stage, polycondensation was started by turning off the nitrogen and by gradually reducing the pressure down to ˜0.05 mbar and the temperature was raised to 220° C. After polycondensation reaction for 3.0 hrs, the vacuum was released by bleeding in nitrogen and the polymer was collected. The random olefinic block copolymer was characterized by SSNMR (FIG. 2). DSC data of the random olefin block copolymer showed a Tₘ and T_{c} of 123° C., 104° C. respectively, TGA in N₂ atmosphere was found to be 455° C. XRD patter of the random OBC had a % crystallinity of 57.6% (FIG. 4) with peaks characteristics peaks of PE at 2θ≈21.7° and 2θ≈24° due to (110) and (200) reflections, and a peak at 36.60 due to (020) plane.

The olefin block co-polymer mimics (OBC-mimic of the present invention) in this Example was made by a hard block which is linear diol with molecular weight of 3000 g/mol and was fully hydrogenated (linear 90 mol %) and soft block (10%) which had molecular weight of 3000 g/mol; with degree of branching 65 mol %. Branching carbon chain length of 2 (2 carbon atoms; vinyl) along with linker which is succinic acid (a di-carboxylic acid) via esterification and condensation reaction. The OBC-mimic (olefin block co-polymer mimic of the present invention) was crystalline (˜57.6%) and had melting temperature Tₘ≈123° C. It is observed that the crystallinity and melting temperature were controlled by the hard (linear) block and the elastomeric property was governed by the soft (branched, commercial diol) block. The results show that the copolymer made in accordance to our invention was a block copolymer having two polyolefin groups that were different from each other and linked by ester groups. One of the polyolefin groups was aliphatic and the other polyolefin group was branched. Each polyolefin group had a degree of saturation of 98% (within the range of 98% to 100%) and 212 carbon atoms (at least 100 carbon atoms). The branched group had a degree of branching that was 12% (within the range of 0.01 to 50%).

### Example 5

### Random Olefin Block Copolymer Synthesis Using α,ω-dihydroxy Polyethylene (40 Mol %), Branched Diol (−65% Branching, 60 mol %), and Succinic Acid

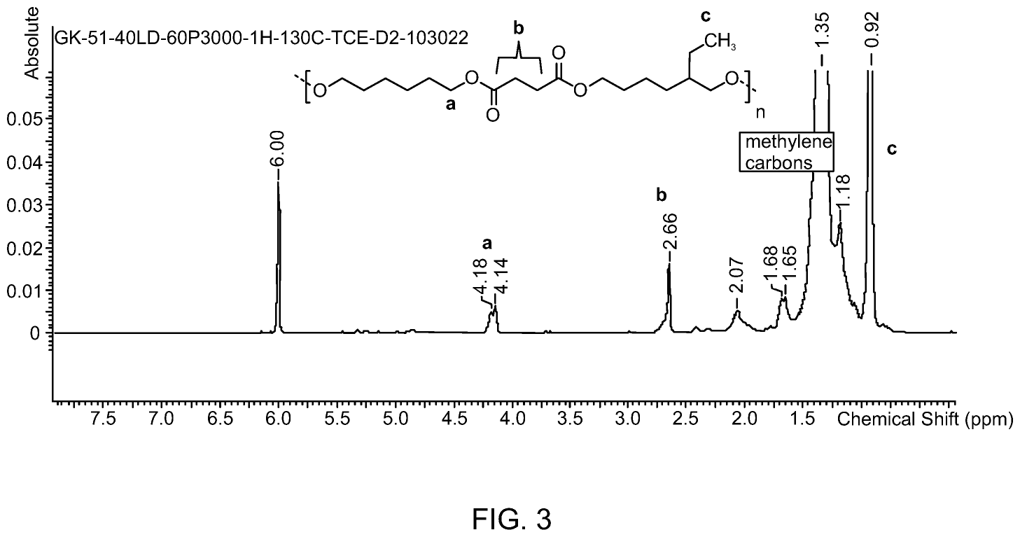

Random olefin block copolymer synthesis using α,ω-dihydroxy polyethylene (40 mol %), a hydrogenated branched diol (65% branching, 60 mol %), and succinic acid was performed as described in Example 4. α,ω-Dihydroxy polyethylene (40 mol %) was made as described in Example 2. The hydrogenated branched diol was made as described in Example 4 (hydrogenation of P-3000, Cray Valley). The random olefinic block copolymer was characterized by ¹H-NMR (FIG. 3). DSC data of the random olefinic block copolymer of the present invention showed a Tm and Tc of 119° C., 101° C. respectively. TGA in N₂ atmosphere was found to be 428° C. XRD patter of random OBC of the present invention showed a % crystallinity 55.8% with peaks characteristics peaks of PE at 2θ≈21.40 and 2θ≈23.80 due to (110) and (200) reflections, a peak at 36.10 due to (020) plane, and a weak/broad shoulder band at ≈19° representing a semi-amorphous phase.

The olefin block co-polymer mimics (OBC-mimic) of the present invention as shown in this Example was made by a hard block which is linear diol with molecular weight of 3000 g/mol and was fully hydrogenated (linear 40 mol %) and soft block (60 mol %) which had molecular weight of 3000 g/mol; with degree of branching 65 mol %. Branching carbon chain length of 2 (2 carbon atoms; vinyl) along with linker which is succinic acid (a di-carboxylic acid) via esterification and condensation reaction. The OBC-mimic (olefin block co-polymer mimic) was crystalline (˜55.8%) and had melting temperature Tₘ˜119° C. It is observed that the crystallinity and melting temperature were controlled by the hard (linear) block and the elastomeric property was governed by the soft (branched) block.

The results as tabulated in Table 1 show that the copolymers of the present invention was a block copolymer having two polyolefin groups that were different from each other and linked by ester groups. One of the polyolefin groups was aliphatic and the other polyolefin group was branched. Each polyolefin group had a degree of saturation of 98% (within the range of 98% to 100%) and 212 carbon atoms (at least 100 carbon atoms). The branched group had a degree of branching that was 12% (within the range of 0.01 to 50%).

TABLE 1

| | Linear Diol | | Branched Diol | | | | | | | PE-Mimic | |
|---|---|---|---|---|---|---|---|---|---|---|---|
| | | [Mₙ] | | [Mₙ] | Degree | Carbon | Hydrog. | Diacid | | —COOH/1000 | Tₘ |
| Ex. | % | (g/mol) | % | (g/mol) | (y %) | length | (%) | (CH₂) | COOH | (CH₂) | ° C. |
| 2 | 90 | 3000 | 10 | 8500 | 12 | 2 | >98 | 2 | 2 | 8.5 | 123 |
| 3 | 90 | 3000 | 10 | 3000 | 65 | 2 | >98 | 2 | 2 | 9.4 | 123 |
| 4 | 40 | 3000 | 60 | 3000 | 65 | 2 | >98 | 2 | 2 | 9.4 | 119 |

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture. compositions of matter, means, methods, or steps.

What is claimed is:

1. A copolymer comprising repeating units of Formula I, and repeating units of Formula II, 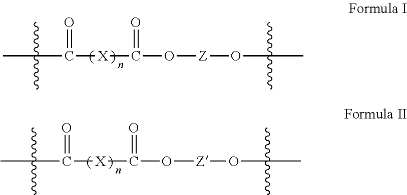
wherein,
n is independently 1 for each of Formula I and II, and denotes number of repeat units;
X is an aliphatic group for each of Formula I and II;
Z is a first polyolefin group comprising at least 45 carbon atoms, preferably 45 to 1,000 carbon atoms, and has a degree of saturation 98 to 100%; and
Z′ is a an aliphatic group,
wherein, the structure of Z is different than Z′, and
wherein Formula I or Formula II, or both, comprise 0.01 to 40 ester groups per 1,000 backbone carbon atoms.

2. The copolymer of claim 1, wherein Z and Z′ independently has a degree of branching (DB) of 0 to 50%, and/or wherein Z and/or Z′ independently comprises branches having independently 1 to 10 carbons.

3. The copolymer of claim 1, wherein Z has a DB of 0 to less than 5% and Z′ has a DB of 5 to 50%.

4. The copolymer of claim 1, wherein Z and/or Z′ are independently polyethylene, polypropylene, poly(ethylene-co-propylene), poly(ethylene-co-1-butene), poly(ethylene-co-1-hexene), or poly(ethylene-co-1-octene) group.

5. The copolymer of claim 1, wherein Z and/or Z′ are independently an atactic, isotactic, or syndiotactic polypropylene.

6. The copolymer of claim 1, wherein X for each of Formula I and II is independently 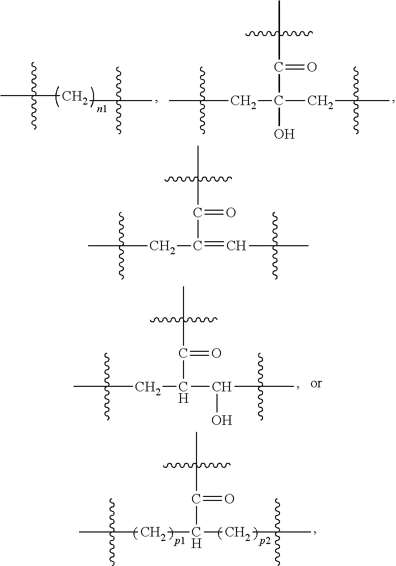
wherein n1 is independently an integer from 1 to 15 for each of Formula I and II, and denotes number of repeat units, p1 is independently 1, 2, or 3 for each of Formula I and II, and denotes number of repeat units, and p2 is independently 1, 2, or 3 for each of Formula I and II, and denotes number of repeat units.

7. The copolymer of claim 1,
i) comprising repeating units of Formula III, and repeating units of Formula IV, or
ii) comprising repeating units of Formula V, and repeating units of Formula VI, or
iii) comprising repeating units of Formula VII, and repeating units of Formula VIII, or
iv) comprising repeating units of Formula IX, and repeating units of Formula X, or
v) comprising repeating units of Formula XIV, and repeating units of Formula XV or XVI,
vi) comprising repeating units of Formula III and Formula XVII, wherein 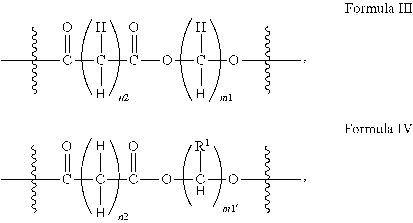
wherein n2 is independently an integer from 0 to 15 for each of Formulas III and IV, and denotes number of repeat units,
m1 is an integer from 45 to 1000, and denotes number of repeat units,
m1′ is an integer from 45 to 1000, and denotes number of repeat units,
R¹ is —H or —CH₂CH₃, and varies independently between —H and —CH₂CH₃ in the repeating units of —CHR₁—, and
the —(CHR¹)_{m1′}— group has a DB of 5 to 50%, 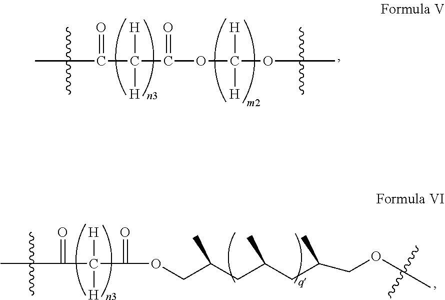
wherein n3 independently is an integer from 0 to 15 for each of Formulas V and VI, and denotes number of repeat units,
m2 is an integer from 60 to 600, and denotes number of repeat units, and
q′ is an integer from 100 to 225, and denotes number of repeat units, 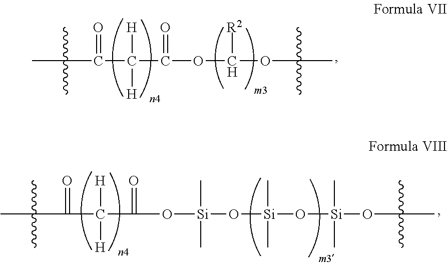
wherein n4 is independently an integer from 0 to 15 for each of Formulas VII and VIII, and denotes number of repeat units,
R² is —H or —CH₂CH₃, and varies independently between —H and —CH₂CH₃ in the repeating units of —CHR₂—, the —(CHR₂)ₘ₃— group has a DB of 0.01 to 50%,
m3 is an integer from 60 to 600, and denotes number of repeat units, and
m3′ is an integer from 1 to 497, and denotes number of repeat units, 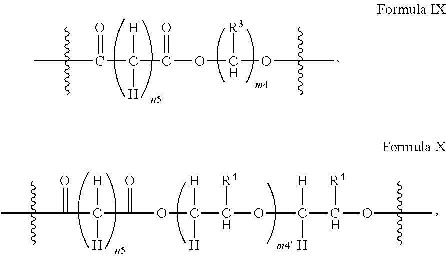
wherein n5 is independently an integer from 0 to 15 for each Formulas IX and X, and denotes number of repeat units,
R³ is —H or —CH₂CH₃, and varies independently between —H and —CH₂CH₃ in the repeating units of —CHR³—,
the —(CHR³)ₘ₄— group has a DB of 0.01 to 50%,
m4 is an integer from 60 to 600, and denotes number of repeat units,
m4′ is an integer from 1 to 332, and denotes number of repeat units, and
R⁴ is a C2 to C10 alkyl group, 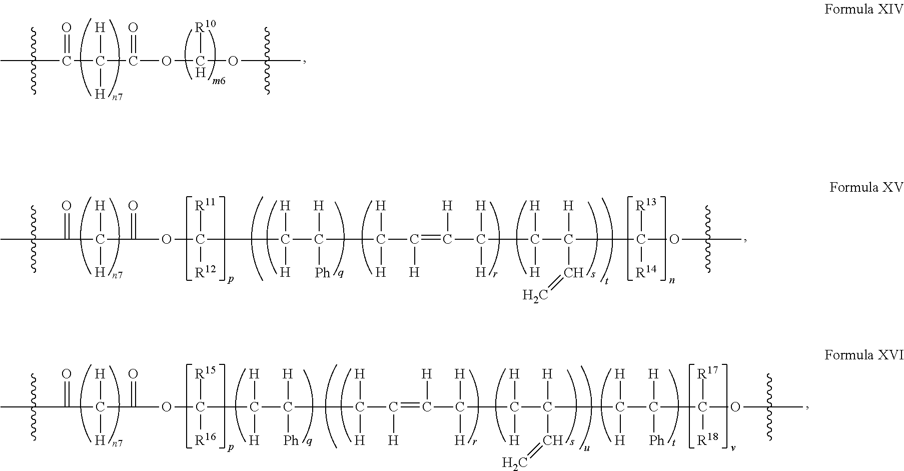
wherein n7 is independently an integer from 0 to 15 for each of Formula XIV, XV and XVI, and denotes number of repeat units,
m6 is an integer from 60 to 600, and denotes number of repeat units,
R¹⁰ is —H or a C₁ to C₁₀ alkyl group, and can vary independently between H and the C₁ to C₁₀ alkyl group in the repeating units of —CHR₁₀—,
the —(CHR¹⁰)ₘ₆— group has a DB of 0.01 to 50%,
R¹¹ is —H or a C₁ to C₁₀ alkyl group, and can vary independently between —H and the C₁ to C₁₀ alkyl group in the repeating units of —CR¹¹R¹²— group,
R¹² can be —H or a C₁ to C₁₀ alkyl group, and can vary independently between —H and the C₁ to C₁₀ alkyl group in the repeating units of —CR¹¹R¹²— group,
R¹³ can be —H or a C₁ to C₁₀ alkyl group, and can vary independently between —H and the C₁ to C₁₀ alkyl group in the repeating units of —CR¹³R¹⁴— group,
R¹⁴ can be —H or a C₁ to C₁₀ alkyl group, and can vary independently between —H and the C₁ to C₁₀ alkyl group in the repeating units of —CR¹³R¹⁴— group, R¹⁵ can be —H or a C₁ to C₁₀ alkyl group, and can vary independently between —H and the C₁ to C₁₀ alkyl group in the repeating units of —CR¹⁵R¹⁶— group, R¹⁶ can be —H or a C₁ to C₁₀ alkyl group, and can vary independently between —H and the C₁ to C₁₀ alkyl group in the repeating units of —CR¹⁵R¹⁶— group, R¹⁷ can be —H or a C₁ to C₁₀ alkyl group, and can vary independently between —H and the C₁ to C₁₀ alkyl group in the repeating units of —CR¹⁷R¹⁸— group, R¹⁸ can be —H or a C₁ to C₁₀ alkyl group, and can vary independently between —H and the C₁ to C₁₀ alkyl group in the repeating units of —CR¹⁷R¹⁸— group,
for Formula XV, p and u are independently an integer from 1 to 5; q, r, s, t are independently integers, wherein (q+r/2+s)×2×t≤1000−p−u, and
for Formula XVI, p and v are independently an integer from 1 to 5; q, r, s, t, u are independently integers, wherein (q+(r/2+s)×u+t)×2<1000−p−v; 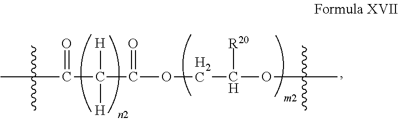
wherein n2 is independently an integer from 0 to 15 and denotes number of repeat units, m2 is an integer from 60 to 600, and denotes number of repeat units, and R¹ is a C₁ to C₁₀ aliphatic hydrocarbon.

8. The copolymer of claim 1, wherein the copolymer is a statistical copolymer.

9. A method for forming the copolymer of claim 1, the method comprising:
reacting i) a first α,ω-dihydroxy compound having a formula of HO—Z—OH, and ii) a second α,ω-dihydroxy compound having a formula of HO—Z′—OH, with an acid or an ester or cyclic anhydride thereof, wherein the acid has the chemical formula of Formula XI 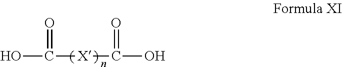
wherein n is 1, and denotes number of repeat units, and
wherein X′ is an aliphatic group.

10. The method of claim 9, wherein X′ is 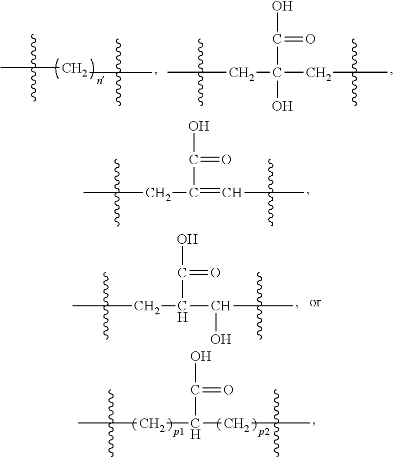
wherein n′ is an integer from 1 to 15, and denotes number of repeat units, and p1 and p2 are independently 1, 2, or 3, and denote number of repeat units.

11. The method of claim 9, wherein the acid is oxalic acid, malonic acid, succinic acid, maleic acid, glutaric acid, adipic acid, pimelic acid, suberic acid, azelaic acid, sebacic acid, citric acid, aconitic acid, isocitric acid, propane-1,2,3-tricarboxylic acid, pentane-1,3,5-tricarboxylic acid, or any combinations thereof.

12. The method of claim 9, wherein the ester of the acid of HOOC—X′—COOH is a methyl, ethyl and/or propyl ester, and/or wherein the cyclic anhydride is malonic anhydride, succinic anhydride, maleic anhydride, glutaric anhydride, adipic anhydride, pimelic anhydride, suberic anhydride, azelaic anhydride, sebacic anhydride or any combinations thereof.

13. The method of claim 9, wherein the reaction conditions include i) a temperature of 90 to 250° C., and/or ii) inert atmosphere and/or vacuum.

14. A method for recycling a copolymer of claim 1, the method comprising contacting the polymer with water and/or an alcohol under conditions suitable to depolymerize the polymer through hydrolysis and/or alcoholysis to produce a first a,w-dihydroxy compound having a formula of HO—Z—OH, a second α,ω-dihydroxy compound having a formula of HO—Z′—OH, and an acid having a formula of Formula XI, and/or an ester thereof, 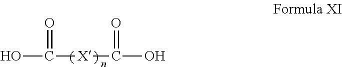
wherein n is 1, and denotes number of repeat units, and
wherein X′ is an aliphatic group.

15. The method of claim 14, wherein X′ is 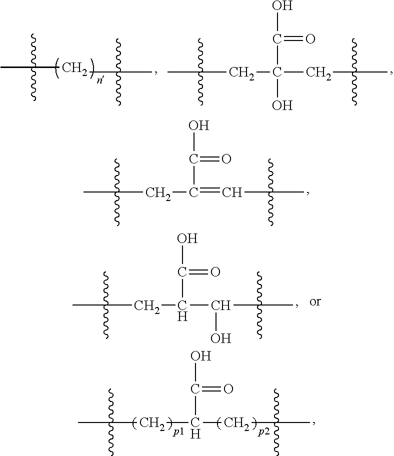
wherein n′ is an integer from 1 to 15, and denotes number of repeat units, and p1 and p2 are independently 1, 2, or 3, and denote number of repeat units.
